(19) United States
(12) Patent Application Publication
(10) Pub. No.: US 2025/0217672 A1
(43) Pub. Date: Jul. 3, 2025

(54) SYSTEM, METHOD EXECUTED BY SYSTEM, AND PROGRAM

(71) Applicant: Hitachi, Ltd., Tokyo (JP)

(72) Inventors: Keiro MURO, Tokyo (JP); Akihiko HYODO, Tokyo (JP)

(21) Appl. No.: 18/977,766

(22) Filed: Dec. 11, 2024

(30) Foreign Application Priority Data
Dec. 28, 2023 (JP) 2023-223531

(51) Int. Cl. G06N 5/022

(52) U.S. Cl. CPC G06N 5/022

(57) ABSTRACT

An object is to realize updating based on the context of a knowledge graph when a document triggers updating of the knowledge graph or realize updating even if the document has been subjected to omission or the like. A document information accepting section accepts document information which is information included in a document that triggers updating of a knowledge graph. A knowledge graph information accepting section accepts knowledge graph information from a knowledge graph system. A prompt constructing section constructs a prompt on the basis of the document information and the knowledge graph information. A response information accepting section accepts response information representing a response from the language model system to the prompt. An update query constructing section constructs the update query on the basis of the response information. An update query presenting section presents the update query to the knowledge graph system.

### CROSS REFERENCE TO RELATED APPLICATIONS

This application claims priority based on Japanese patent application No. 2023-223531, filed on Dec. 28, 2023, the entire contents of which are incorporated herein by reference.

### BACKGROUND OF THE INVENTION

### 1. Field of the Invention

The present disclosure relates to a technology to update knowledge graphs.

### 2. Description of the Related Art

In managing or running a social or economic infrastructure including a facility (e.g., a plant or a factory), it is often premised conventionally that documents and manual work are used. For example, knowledge about a facility or an infrastructure is recorded in documents, or the knowledge is personally recognized by experts on the facility or the infrastructure. In some possible situations with such a premise, designing/operational use/maintenance tasks related to the facility or the infrastructure are performed on the basis of the documents or implemented personally relying on the experts.

Meanwhile, technologies used for a facility or an infrastructure have continuingly become more sophisticated (quality of the knowledge has been improved), and system configurations at the facility or the infrastructure have continuingly become more complicated (the amount of the knowledge has been increased). Accordingly, it is expected that it becomes difficult to appropriately perform designing/operational use/maintenance tasks related to a facility or an infrastructure with a technique in which knowledge about the facility or the infrastructure is managed using documents. In addition, there are concerns about a shortage of experts in various fields, and it is expected that it also becomes difficult to transfer personal knowledge, due to the declining labor force caused by the declining birthrate and aging population.

In recent years, use of a language model trained with machine learning (a language model whose number of model parameters or number of pieces of training data used for training are enormous is also called a large language model (LLM)) for tasks or the like has been explored. When a prompt including question contents is input to a language model, the language model presents a response to the question.

It is expected that a language model is used for designing/operational use/maintenance tasks related to a facility or an infrastructure and the tasks are made efficient.

There are fine tuning and retrieval augmented generation (RAG) as techniques for making a language model suited for some task (for making the language model suited for an inquiry (prompt) about particular domain knowledge). Fine tuning techniques require a cost of retraining of a language model (e.g., a cost of retraining for learning particular domain knowledge). In a case of a situation where the amount of training data used for retraining is enormous or training data keeps being added (modified) frequently, fine tuning techniques are unlikely to be adopted.

In RAG techniques, retraining of a language model is not performed, but the language model refers to external knowledge (e.g., external knowledge covering particular domain knowledge). The external knowledge referred to by the language model can be a vector store or a knowledge graph. Because one knowledge graph can include knowledge included in a plurality of documents, it is suited for responding to an inquiry (prompt) about knowledge across a plurality of documents.

There is JP-2022-129515-A as a prior art document related to knowledge graphs. In a technology disclosed in JP-2022-129515-A (e.g., see FIG. 14), an operator inputs document data to a knowledge model creation assisting apparatus, the knowledge model creation assisting apparatus causes a graphical user interface (GUI) window to display a plurality of terms on the basis of the document data, the operator inputs a term selection result via the GUI window, and (in a case where a predetermined condition is satisfied) the knowledge model creation assisting apparatus causes the GUI window to display a knowledge model (knowledge graph) in a mode in which a knowledge model (knowledge graph) is rendered in such a manner to newly include the term.
Prior art document: JP-2022-129515-A

### SUMMARY OF THE INVENTION

In a case where it is attempted to make designing/operational use/maintenance tasks related to a facility or an infrastructure efficient while a language model based on the RAG technique in which a knowledge graph is externally referred to is used for the tasks, the knowledge graph is updated in response to updating of knowledge about the facility or the infrastructure.

Here, in a case where the knowledge graph is updated manually on the basis of the contents of a document (e.g., a maintenance document) representing updated contents of knowledge about the facility or the infrastructure, a human cost and a temporal cost increase. For example, although the technology disclosed in JP-2022-129515-A assists updating of a knowledge graph (a knowledge model, as expressed by a term used in JP-2022-129515-A) depending on the contents of document data, it requires determination by an operator or time and effort of work. In terms of continuous operational use of a knowledge graph, the rate of manual involvement is desired to be lowered.

In view of this, use of a language model also for updating of a knowledge graph can be considered. Specifically, it can be considered to automatically construct (as much as possible), with use of a language model, an update query acting on the knowledge graph that reflects the contents of a document (e.g., a maintenance document) representing updated contents of knowledge about a facility or an infrastructure and that matches the specifications or the like of the knowledge graph.

However, construction of an update query based on the contents of a document with use of a language model can have several problems.

First, generation of a response with expected contents by a language model (a response suited for the purpose of constructing an update query) often requires devising of the contents of a prompt input to the language model. For example, in a case where training by machine learning specialized for a particular knowledge domain has not been done for a language model, it is often desirable that a prompt input to the language model include knowledge (hints) related to the particular knowledge domain.

Here, in a case where a knowledge graph is updated in response to updating of knowledge about a facility or an infrastructure, there can be cases where the type of a knowledge domain related to the facility or the infrastructure or the knowledge graph which is the target of the updating determines knowledge (hints) which is suitable to be included in a prompt (or determines the contents of the prompt other than the knowledge (hints) in some cases). In a case where a prompt is constructed manually, there is a risk that a creator creates the prompt by trial and error.

It is desirable that the degree of automation of processes be maintained high while construction of a prompt with contents depending on the type of a knowledge domain or an update-target knowledge graph is realized. Further, it is desirable to update a knowledge graph on the basis of context that the knowledge graph has.

In addition, there can be cases where a document (e.g., a maintenance document) represented by updated contents of knowledge about a facility or an infrastructure is not created to represent description contents that are appropriate and sufficient for appropriately performing updating of a knowledge graph.

Specifically, there can be cases where the description contents of a document (e.g., a maintenance document) are short or fragmentary. There can be cases where such a document does not appropriately and sufficiently describe information about nodes and edges in an update-target knowledge graph (e.g., information about assets included in a facility or an infrastructure) (some descriptions are omitted). For example, there can be cases where the document lacks a description about the relation between assets or, even if the document describes the types of assets, the document lacks a description about the identifiers of the assets.

In addition, for example, in a case where there are a plurality of people who can create a document (e.g., a maintenance document), there can be writing variations of terms described in the document. For example, there can be cases where some person writes, in a document, about assets included in a facility or an infrastructure by using their formal names in Japanese, some other person writes, in the document, about the assets by using other names of the assets in Japanese, and still some other person writes, in the document, about the assets by using abbreviations of the assets in alphabet.

Further, for example, there can be cases where a symptom that has occurred to an asset included in a facility or an infrastructure, a cause of the symptom, and a measure taken against the symptom are not written as a set in a document (e.g., a maintenance document). There can be cases where a document like this is not enough to appropriately recognize a symptom that has occurred to an asset, a cause of the symptom, and a measure taken against the symptom.

It is desirable that, after the contents of a document (e.g., a maintenance document) represented by updated contents of knowledge about a facility or an infrastructure have been supplemented or corrected as appropriate, the degree of automation of processes be maintained high while construction of a prompt with suitable contents is realized.

Note that the technology disclosed in JP-2022-129515-A does not construct a prompt after the contents of document data have been supplemented or corrected automatically.

It is assumed in the description above that a knowledge graph is externally referred to by a language model using the RAG technique. In addition, updating of a knowledge graph depending on a document (e.g., a maintenance document) representing updated contents of knowledge about a facility or an infrastructure has been described.

However, an update-target knowledge graph may be one that is used not to be externally referred to by a language model using the RAG technique. In addition, a knowledge graph may be used for a digital twin or the like.

In addition, the target of knowledge represented by an update-target knowledge graph may be one other than a facility and an infrastructure. It is sufficient if the document triggers updating of a knowledge graph.

Typically, as long as a knowledge graph is updated as triggered by a document (while the degree of automation of the updating is maintained high) and also there is an object of updating the knowledge graph on the basis of context that the knowledge graph has or updating the knowledge graph even if the description contents of the document have been subjected to omission or the like, the use of the knowledge graph, the target of knowledge represented by the knowledge graph, and the type of the document that triggers the updating of the knowledge graph may be any use, target, and type.

Taking into account what has been described above, one of objects of the present disclosure may be to maintain high the degree of automation of updating of a knowledge graph as triggered by a document when the updating is performed, and to realize the updating based on context that the knowledge graph has or to realize the updating even if the description contents of the document has been subjected to omission or the like.

In order to attain at least one of the objects described above, features that the present disclosure can include are as follows, for example.

One aspect of the present disclosure relates to a system. A system has a document information accepting section, a knowledge graph information accepting section, a prompt constructing section, a prompt presenting section, a response information accepting section, an update query constructing section, and an update query presenting section. The document information accepting section accepts document information which is information included in a document that triggers updating of a knowledge graph. The knowledge graph information accepting section accepts knowledge graph information which is information included in the knowledge graph from a knowledge graph system that manages the knowledge graph. The prompt constructing section constructs a prompt on the basis of the document information and the knowledge graph information. The prompt is for requesting presentation of information to be used for construction of an update query for updating the knowledge graph. The prompt presenting section presents the prompt to a language model system that manages a language model. The response information accepting section accepts response information representing a response from the language model system to the prompt. The update query constructing section constructs the update query on the basis of the response information. The update query presenting section presents the update query to the knowledge graph system.

As described above, in the present disclosure, the prompt is constructed on the basis of the document information which is information included in the document that triggers updating of the knowledge graph and the knowledge graph information which is information included in the knowledge graph. Here, since the knowledge graph information represents context that the knowledge graph has, the prompt constructed on the basis of the knowledge graph information can be made an appropriate prompt based on the context that the knowledge graph has. Alternatively, even if the description contents of the document represented by the document information have been subjected to omission or the like, an appropriate prompt can be constructed after a portion having been subjected to the omission or the like has been substantially supplemented or corrected on the basis of the knowledge graph information.

Response information or an update query corresponding to an appropriate prompt as described above also becomes appropriate response information or an appropriate update query. That is, updating of the knowledge graph is also realized appropriately.

In addition, in the present disclosure, a series of processes including the acceptance of the knowledge graph information from the knowledge graph system, the construction of the prompt, the presentation of the prompt to the language model system, the acceptance of the response information from the language model system, the construction of the update query, and the presentation of the update query to the knowledge graph system is performed in response to the acceptance of the document information which is the information included in the document that triggers updating of the knowledge graph, and the degree of automation of the processes ranging from the acceptance of the document information to the updating of the knowledge graph is maintained high.

Accordingly, the present disclosure can maintain high the degree of automation of updating of a knowledge graph as triggered by a document when the updating is performed, and also realize the updating based on context that the knowledge graph has or realize the updating even if the description contents of the document have been subjected to omission or the like.

A method and a program that realize matters similar to processes realized by the system described above can also attain effects and advantages similar to those of the system described above. If a mode of a program is adopted, expenses are reduced in many cases. In the case of the program, design changes about processes are also easy to make.

Features that the present disclosure can have other than those described above as well as effects and advantages corresponding to the features are disclosed in this specification, claims, or figures.

### BRIEF DESCRIPTION OF THE DRAWINGS

FIG. 1 depicts the basic functional configuration of an embodiment of the present disclosure;

FIG. 2 depicts the computer architecture of a system;

FIG. 3 depicts an example of the structure of a knowledge graph;

FIG. 4 depicts an example of node information;

FIG. 5 depicts an example of edge information;

FIG. 6 depicts the functional configuration of prompt construction using hint information;

FIG. 7 depicts the functional configuration of prompt construction using set-of-hints information;

FIG. 8 depicts a flowchart of prompt construction or the like;

FIG. 9 depicts an example of prompt construction;

FIG. 10 depicts a knowledge graph in a first case example;

FIG. 11 depicts document information, knowledge graph information, and response information in the first case example;

FIG. 12 depicts a knowledge graph in a second case example;

FIG. 13 depicts document information, knowledge graph information, and response information in the second case example;

FIG. 14 depicts a knowledge graph in a third case example;

FIG. 15 depicts document information, knowledge graph information, and response information in the third case example;

FIG. 16 depicts the functional configuration of optimization of set-of-hints information or the like;

FIG. 17 depicts a flowchart of optimization;

FIG. 18 depicts a functional configuration related to displaying of a supplementary document;

FIG. 19 depicts displaying of a supplementary document;

FIG. 20 depicts a functional configuration related to displaying of a uniqueness inquiry;

FIG. 21 depicts displaying of a uniqueness inquiry;

FIG. 22 depicts the functional configuration of editing of knowledge graph information;

FIG. 23 depicts displaying of editing of knowledge graph information;

FIG. 24 depicts the functional configuration of a modification example of construction of an asset identification request prompt;

FIG. 25 depicts an asset identification request prompt template;

FIG. 26 depicts a modification example of a flowchart of prompt construction or the like;

FIG. 27 depicts a modification example of set-of-hints information;

FIG. 28 depicts the functional configuration of a modification example related to displaying of a supplementary document; and

FIG. 29 depicts the functional configuration of a modification example related to displaying of a uniqueness inquiry.

### DESCRIPTION OF THE PREFERRED EMBODIMENT

Hereinbelow, an embodiment of the present disclosure is explained in detail with reference to the figures. Note that the embodiment explained below does not limit the disclosure according to claims, and all of elements explained in the embodiment and combinations thereof are not necessarily essential for means for solving the present disclosure. The description and figures described below illustrate examples for explaining the present disclosure, and, for clarification of the explanation, there are omissions and simplifications as appropriate. The present disclosure can also be implemented in various other modes. Unless there is a particular limitation, the numbers of respective constituent elements may be one or greater than one. The position, size, shape, area, and the like of each constituent element depicted in the figures do not represent its actual position, size, shape, area, and the like in some cases in order to facilitate understanding of the invention. Because of this, the present disclosure is not necessarily limited to positions, sizes, shapes, areas, and the like disclosed in the figures.

Each of systems, apparatuses, and functional sections of the present disclosure may be integrated into one in a form of hardware, or may be one that includes a plurality of separate portions and plays a role through coordination between the portions. Several systems, apparatuses, or functional sections may be integrated in a form of hardware.

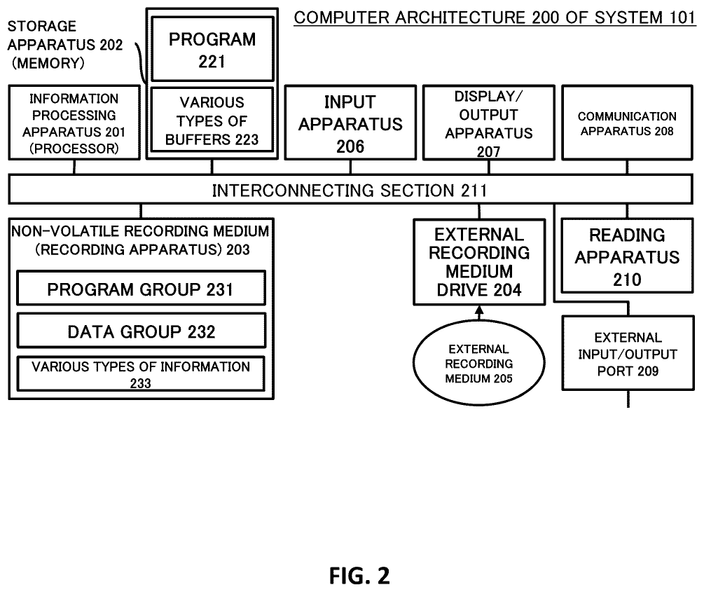

Each of systems, apparatuses, and functional sections may be realized by causing a computer to execute software (program) (as in FIG. 2). Some of functions of systems, apparatuses, or functional sections may be realized by hardware (e.g., hardwired logic or a field programmable gate array (FPGA)), and the remaining functions may be realized by execution of software (program). All of functions of each of systems, apparatuses, or functional sections may be realized in a form of hardware. Some or all of steps depicted in flowcharts and the like explained in the present disclosure may be realized in a form of hardware.

One or more of systems, apparatuses, and functional sections of the present disclosure may be realized by one or more hardware resources. Because of this, each of systems, apparatuses, and functional sections of the present disclosure may be realized virtually. For example, virtual computers or container techniques may be used.

A program of the present disclosure may be anything that is included in the concept covering ones in general that are equivalent to software by which an information processing system (system) or an operation method therefor unique to purposes of use is constructed through collaboration between the software and hardware resources. That is, the program of the present disclosure is not limited to a particular type or mode of program. In addition, the program may initially be recorded in a compressed format.

Ones for which the same reference numerals are used throughout a plurality of figures are similar to each other. In figures depicting flowcharts, oblong boxes represent steps of processes, and hexagonal boxes represent steps of conditional branches. In figures depicting flowcharts, “Steps” are abbreviated to “S.” In addition, the modes of displaying or outputting represented by the figures depict mere examples. The modes of displaying or outputting may be different from those depicted in the figures within the scope of the aim of the present disclosure.

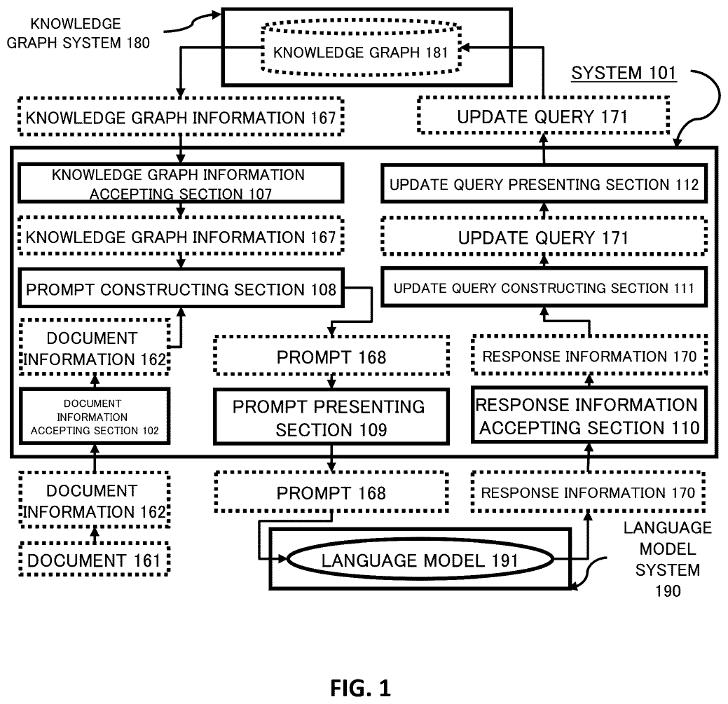

### 1. Basic Functional Configuration (FIG. 1)

FIG. 1 depicts the basic functional configuration 100 of (and information to be handled by) a system of an embodiment of the present disclosure. Note that the entire functional configuration depicted in FIG. 1 is not necessarily essential. In addition, the presence of a functional configuration other than the functional configuration depicted in FIG. 1 is not precluded.

A system 101 may be made capable of mutual communication with a knowledge graph system 180 and a language model system 190.

The knowledge graph system 180 manages a knowledge graph 181. The knowledge graph system 180 responds to a request for information that the knowledge graph 181 has. In addition, the knowledge graph system 180 updates the knowledge graph 181 in response to an update query 171 about the knowledge graph 181. Here, updating of the knowledge graph 181 may be updating of information about a node/edge/subgraph existing in the knowledge graph 181 or may be updating to newly add a node/edge/subgraph to the knowledge graph 181. For example, the knowledge graph 181 may represent knowledge about a facility or an infrastructure, but the contents of knowledge represented by the knowledge graph 181 are not particularly limited to any type.

The language model system 190 manages a language model 191. When a prompt 168 including the contents of a question is presented to the language model 191, the language model 191 generates (outputs) response information 170 representing a response to the question. The language model 191 is constructed by training by machine learning. It should be noted that the language model 191 has not necessarily been trained by machine learning specialized for domain knowledge to which the knowledge represented by the knowledge graph 181 belongs. In a case where the number of model parameters that the language model 191 has is enormous or in a case where the number of pieces of training data used for training of the language model 191 is enormous, the language model 191 may be called an LLM.

Note that, whereas FIG. 1 represents that the knowledge graph 181 and the language model 191 are located outside the system 101, one of or both the knowledge graph 181 and the language model 191 may be located inside the system 101.

The system 101 presents the update query 171 for requesting updating of the knowledge graph 181, depending on a document 161 that triggers updating of the knowledge graph 181. Here, for example, the document 161 may be a maintenance document about a facility or an infrastructure, but the type of the document 161 is not particularly limited to any type. For example, the document 161 may be another type of document about a facility or an infrastructure or may be a document about one other than a facility and an infrastructure.

As functional sections, the system 101 may have a document information accepting section 102, a knowledge graph information accepting section 107, a prompt constructing section 108, a prompt presenting section 109, a response information accepting section 110, an update query constructing section 111, and an update query presenting section 112. Each of these functional sections may be realized by execution of a program or may be implemented in a form of hardware.

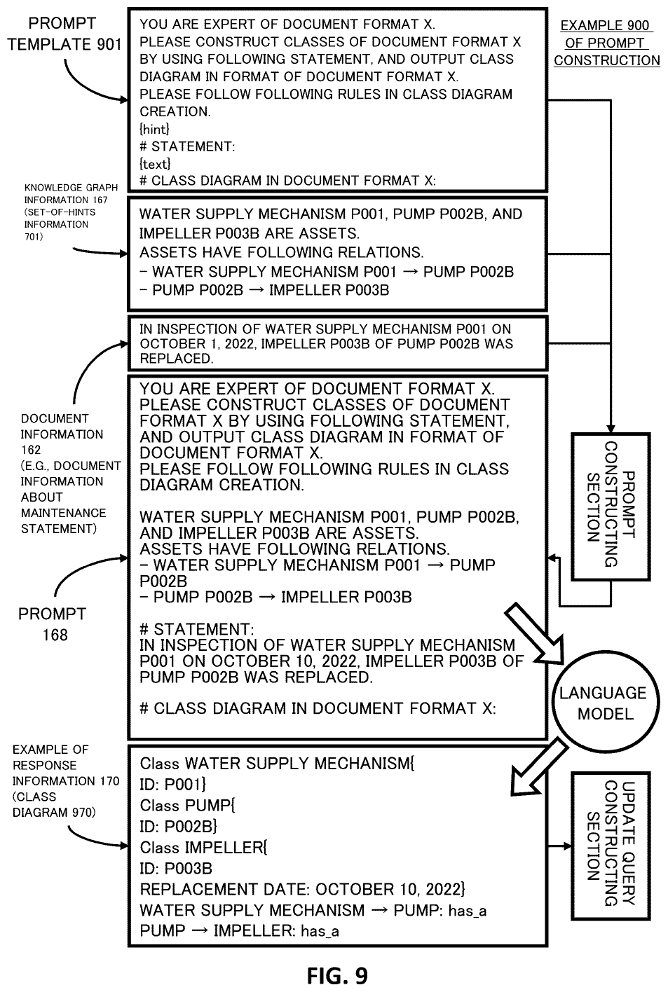

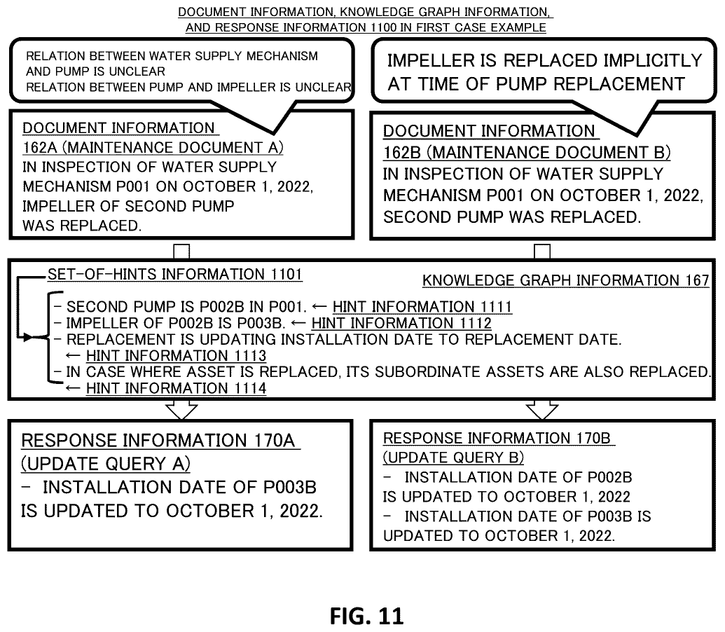

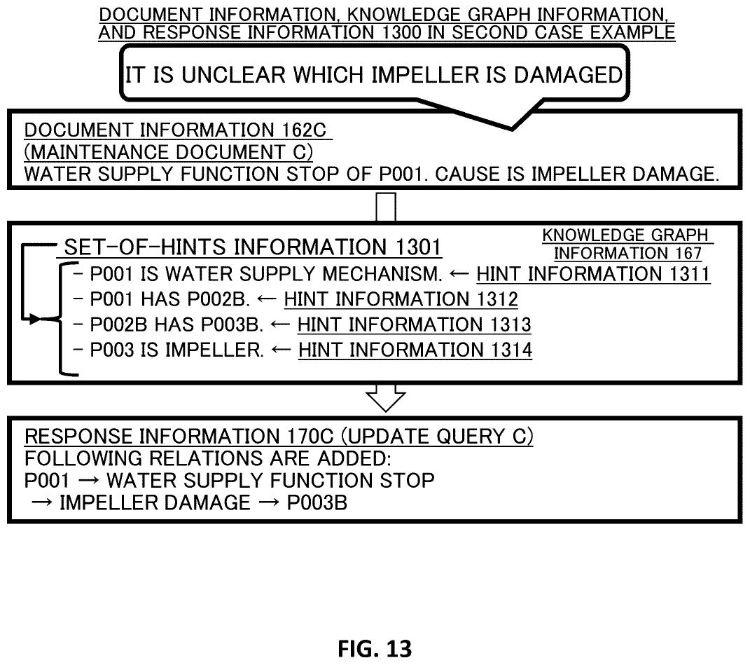

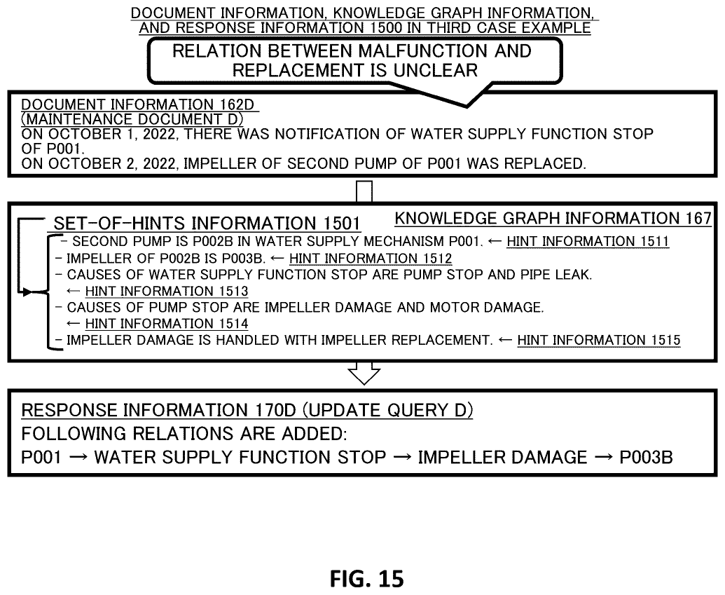

The document information accepting section 102 accepts document information 162 which is information included in the document 161. Here, for example, the contents of the document 161 or the document information 162 may be like the one depicted in FIG. 9, FIG. 11, FIG. 13, or FIG. 15 described later. Note that the system that provides the document information 162 to the system 101 may be some client system that is made capable of mutual communication with the system 101. Alternatively, a person (e.g., an operator) who handles a facility, an infrastructure, or the like related to knowledge represented by the knowledge graph 181 may directly provide the document information 162 (document 161) to the system 101 manually via an input apparatus 206 (see FIG. 2).

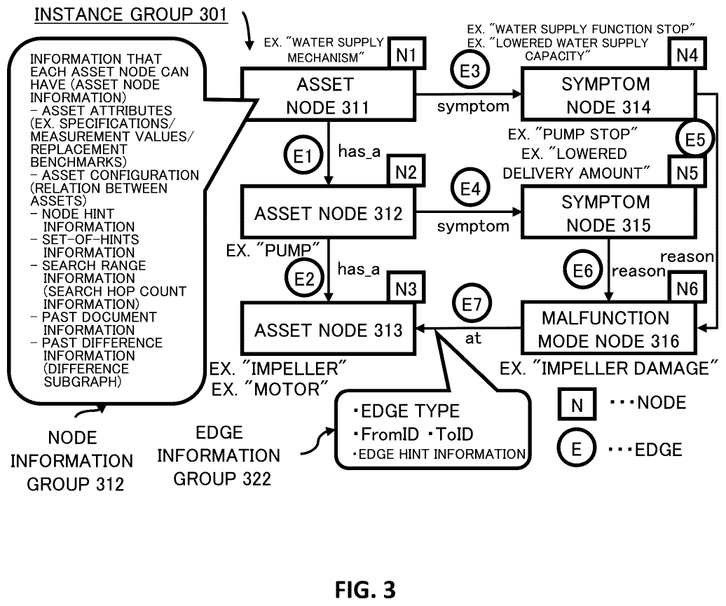

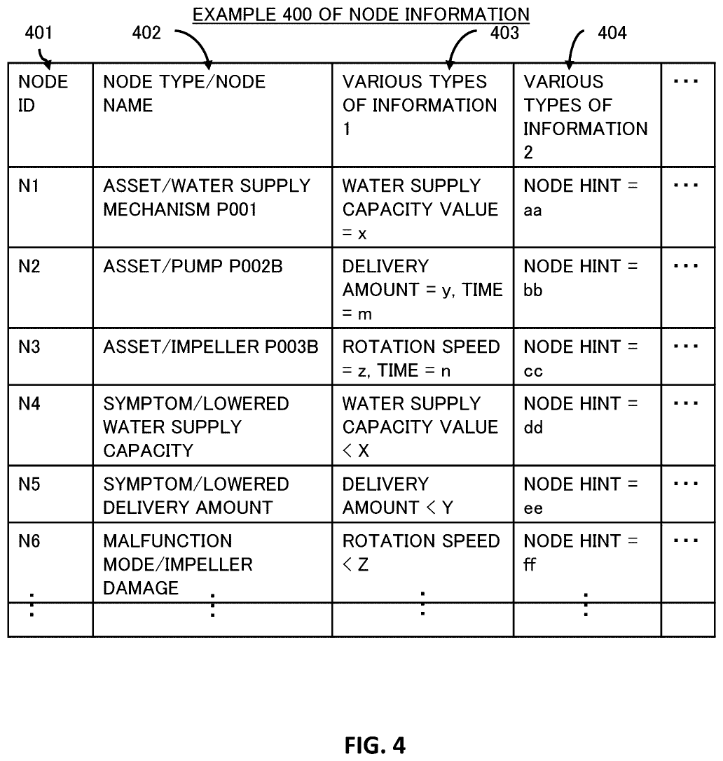

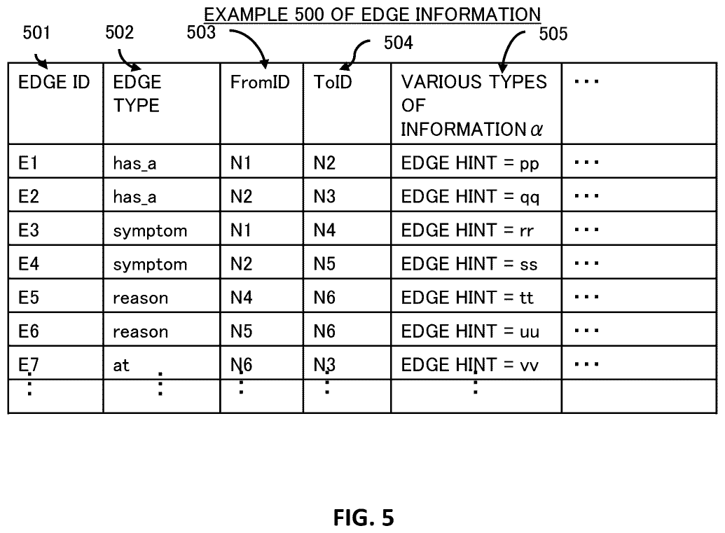

The knowledge graph information accepting section 107 accepts, from the knowledge graph system 180, knowledge graph information 167 which is information included in the knowledge graph 181. For example, the contents of the knowledge graph information 167 may be information about a node/edge/subgraph of the knowledge graph 181. For example, the knowledge graph information 167 may be in a mode of hint information or set-of-hints information. For example, the contents of the knowledge graph information 167 may be like the one depicted in FIG. 3, FIG. 4, FIG. 5, FIG. 9, FIG. 11, FIG. 13, or FIG. 15 described later.

The prompt constructing section 108 constructs the prompt 168 on the basis of the document information 162 and the knowledge graph information 167. The prompt 168 is for requesting the language model 191 to present information (response information 170) to be used for construction of the update query 171 for updating the knowledge graph 181. The prompt 168 is based not only on the document information 162 which is information included in the document 161 that triggers updating of the knowledge graph 181, but also on the knowledge graph information 167. By constructing the prompt 168 on the basis of the knowledge graph information 167, it can be expected that the prompt 168 based on context that the knowledge graph 181 has is constructed or that the prompt 168 is constructed after a portion having been subjected to omission or the like in the document information 162 has been supplemented or corrected.

For example, as depicted in FIG. 9 described later, the prompt constructing section 108 may construct the prompt 168 by inserting the document information 162 and the knowledge graph information 167 (set-of-hints information 701 in FIG. 9) to a relevant portion of a prompt template 901. It should be noted that the technique for constructing the prompt 168 is not limited to any type as long as the prompt 168 is constructed using the document information 162 and the knowledge graph information 167.

The prompt presenting section 109 presents the prompt 168 to the language model system 190. Along with this, the language model system 190 inputs the prompt 168 to the language model 191. The language model 191 generates a response to the question represented by the prompt 168, and outputs the response as the response information 170. The language model system 190 provides the response information 170 to the system 101.

The response information accepting section 110 accepts the response information 170 from the language model system 190. It is sufficient if the response information 170 is information to be used for construction of the update query 171, and the format of the response information 170 may be any format. That is, the format of the response information 170 may not be the format of the update query 171 itself. For example, the response information 170 may be in a mode (e.g., a class diagram) representing classes in a PlantUML format like the one depicted in FIG. 9 described later or may be in a mode of statements or in a mode of writing using symbols like the one depicted in FIG. 11, FIG. 13, or FIG. 15 described later.

The update query constructing section 111 constructs the update query 171 on the basis of the response information 170. The update query constructing section 111 constructs the update query 171 in a format that can be accepted by the knowledge graph system 180. For example, in a case where the knowledge graph system 180 is in a form of a certain type of database system, the update query 171 may be a statement in a format that can be accepted by the database system (e.g., a Structured Query Language (SQL) statement). In addition, for example, in a case where the knowledge graph system 180 includes a control apparatus that controls a recording medium on which the knowledge graph 181 is stored and that does not perform complicated control, the update query 171 may be in a mode to instruct an internal structure in the knowledge graph 181 (such a structure as a table retaining information about a node/edge/subgraph or the like) to perform direct operation.

Note that, in a case where the format of the response information 170 is the same as the format of the update query 171, the update query constructing section 111 may not exist, or the update query constructing section 111 may allow the response information 170 to pass therethrough as it is and treat the response information 170 as the update query 171.

The update query presenting section 112 presents the update query 171 to the knowledge graph system 180. The knowledge graph system 180 updates the knowledge graph 181 according to updated contents represented by the update query 171. Updating of the knowledge graph 181 may be updating of information about a node/edge/subgraph existing in the knowledge graph 181 (like the one depicted in FIG. 11 described later) or may be updating to newly add a node/edge/subgraph to the knowledge graph 181 (like the one depicted in FIG. 13 or FIG. 15 described later).

Since it is possible to expect that the prompt 168 is constructed appropriately as described before, it can be expected that the response information 170 and the update query 171 obtained on the basis of the prompt 168 and updating, based on the update query 171, of the knowledge graph 181 also become ones based on context that the knowledge graph 181 has, or become ones reflecting supplementation or correction of a portion having been subjected to omission or the like in the document information 162.

Since the system 101 in the embodiment of the present disclosure has a functional configuration like the one described above, the system 101 can attain advantages depicted in paragraphs [0013] to [0016] described before.

### 2. Computer Architecture for Realizing Embodiment of Present Disclosure (FIG. 2)

FIG. 2 represents a computer architecture 200 for realizing the system 101 of the embodiment of the present disclosure.

In order to realize the system 101, some or all of an information processing apparatus 201, a storage apparatus 202, a non-volatile recording medium (recording apparatus) 203, an external recording medium drive 204, the input apparatus 206, a display/output apparatus 207, a communication apparatus 208, an external input/output port 209, and a reading apparatus 210 may be interconnected by an interconnecting section 211. (Note that part or the whole of the interconnecting section 211 may be a network. In that case, the system 101 is realized by a plurality of apparatuses connected via the network.)

For example, the information processing apparatus 201 may be a processor. Examples of the processor include a central processing unit (CPU), a micro processing unit (MPU), and a graphics processing unit (GPU). Alternatively, the processor described here may be another semiconductor device as long as the semiconductor device executes predetermined processes. In addition, the information processing apparatus 201 may be one or more (micro)processors. For example, the storage apparatus 202 may be a memory. For example, the non-volatile recording medium (recording apparatus) 203 may be a non-volatile memory (e.g., a flash memory) or a non-volatile disk apparatus. For example, the external recording medium drive 204 may be a disk drive. For example, the input apparatus 206 may be a mouse, a keyboard, an image-capturing apparatus, a sensor, a touch panel, or a pointing device. For example, the display/output apparatus 207 may be a display, a printer, or a speaker. For example, the communication apparatus 208 may be a communication apparatus for wired communication or a communication apparatus for wireless communication. The communication apparatus 208 may be a network interface apparatus (network interface card (NIC)) that controls communication with another system, apparatus, terminal, or server in accordance with a predetermined protocol. For example, the interconnecting section 211 may be a bus or a crossbar switch. (As described before, part or the whole of the interconnecting section 211 may be a network.)

Various types of programs included in a program group 231 (e.g., programs for realizing the functional configuration according to the present disclosure; for example, various types of programs for implementing each of the functional sections realized by the system 101), various types of data groups included in a data group 232, or various types of information 233 may be recorded on the non-volatile recording medium (recording apparatus) 203.

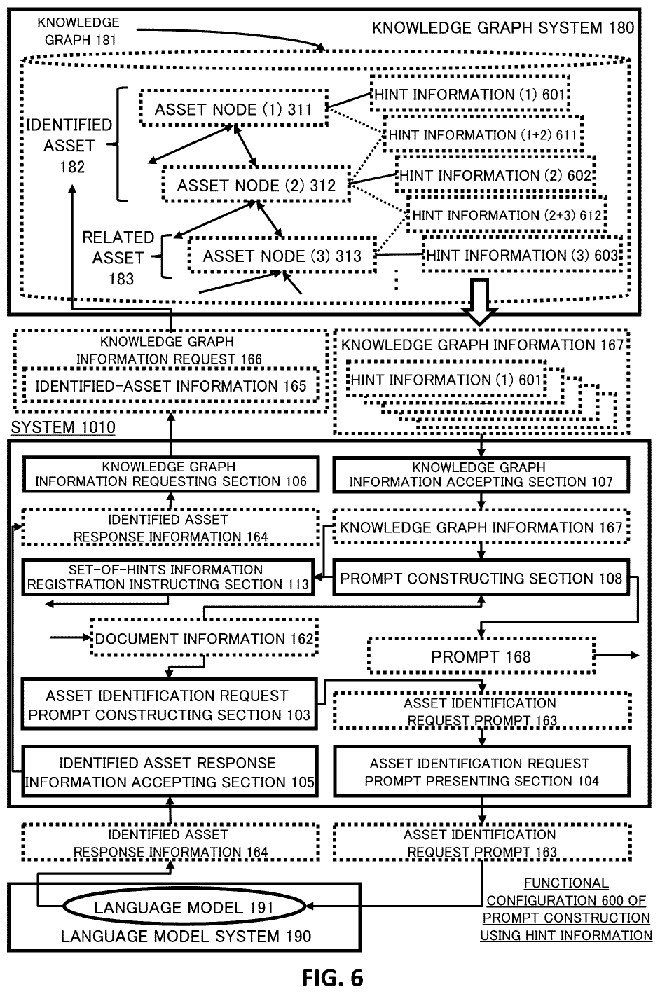

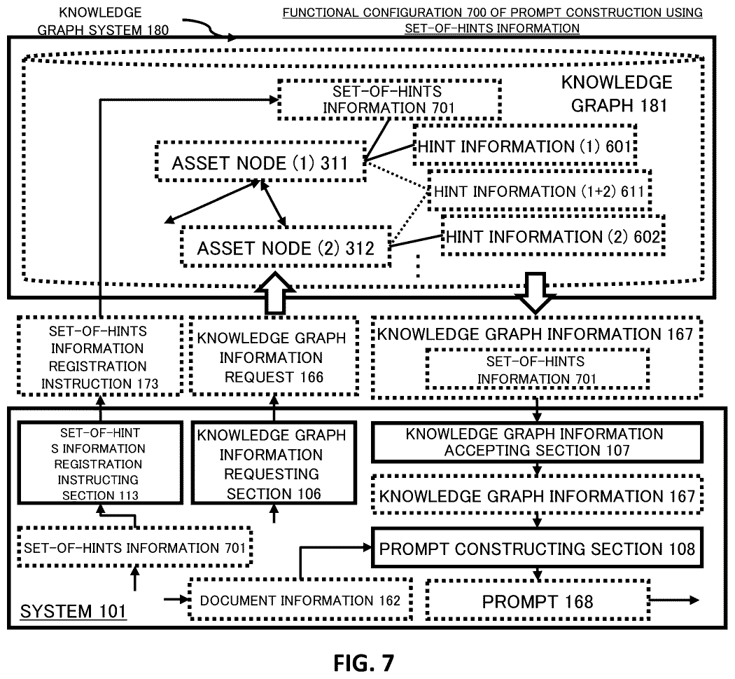

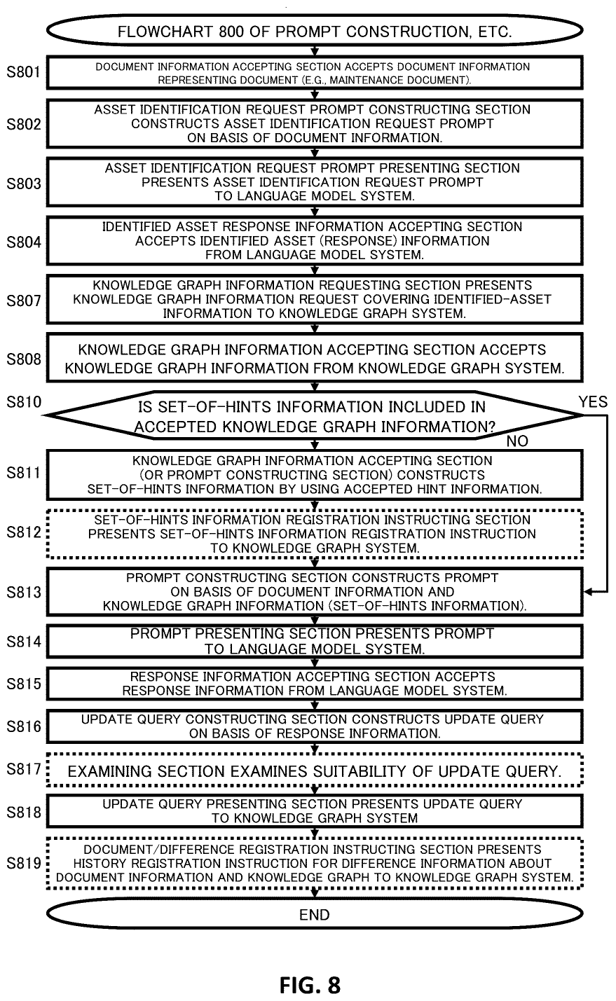

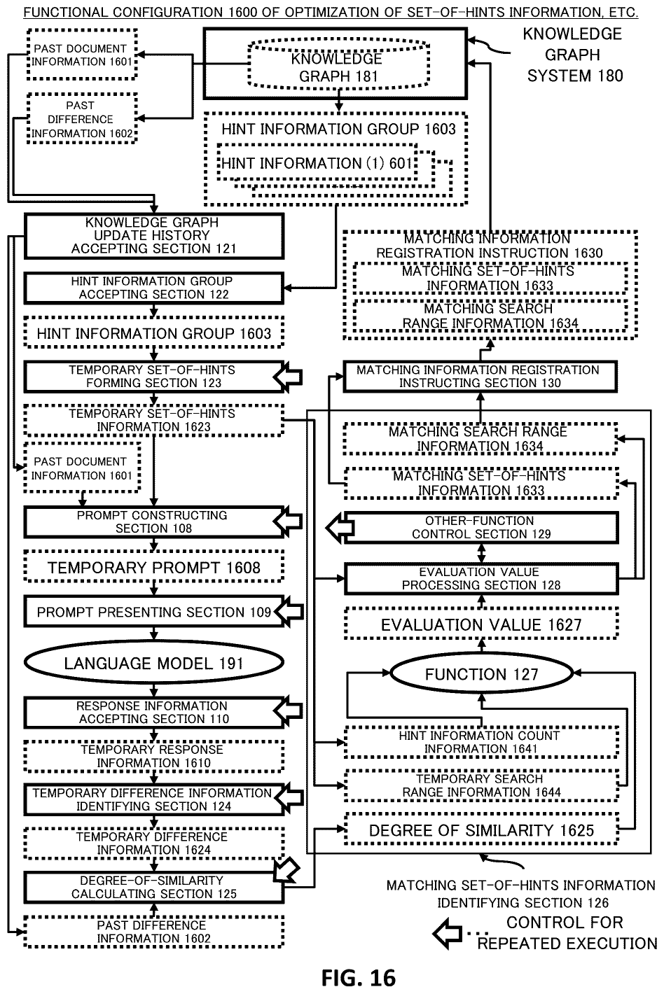

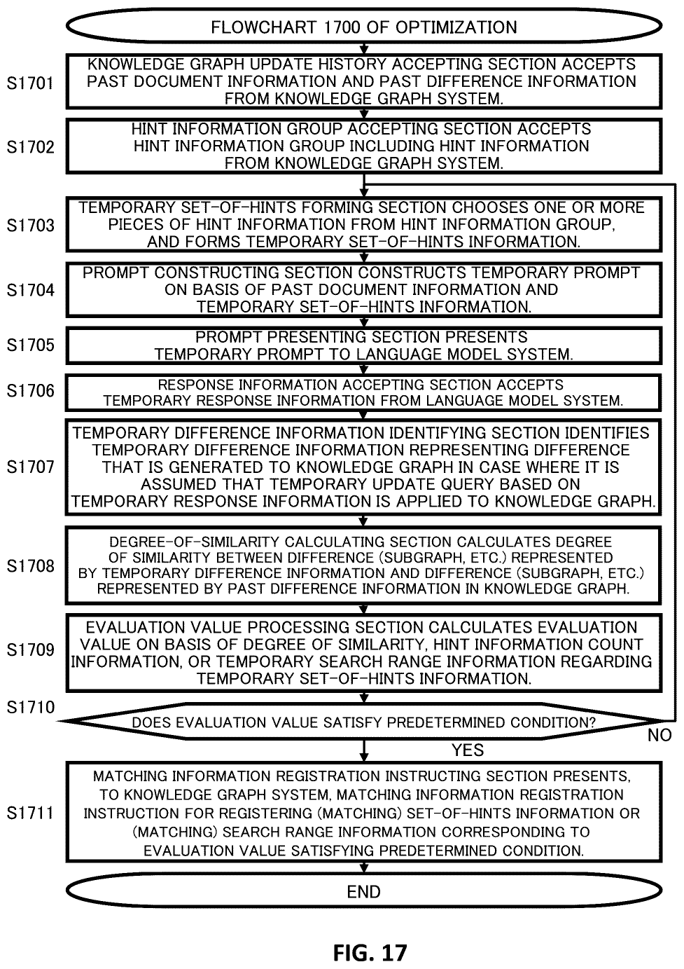

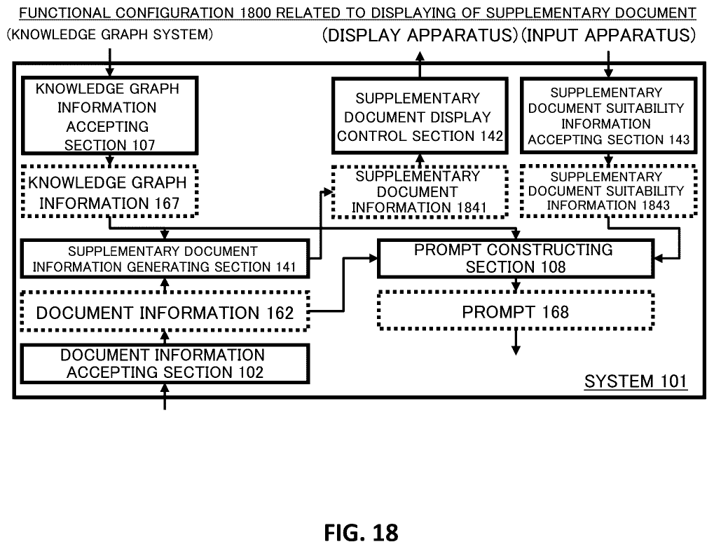

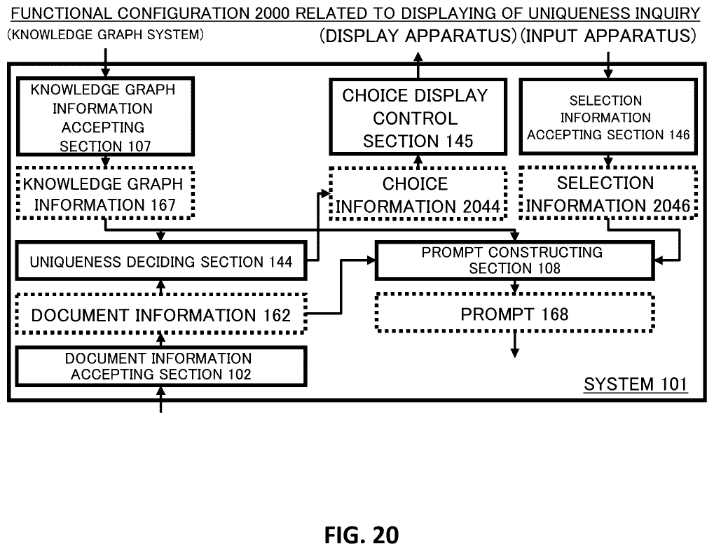

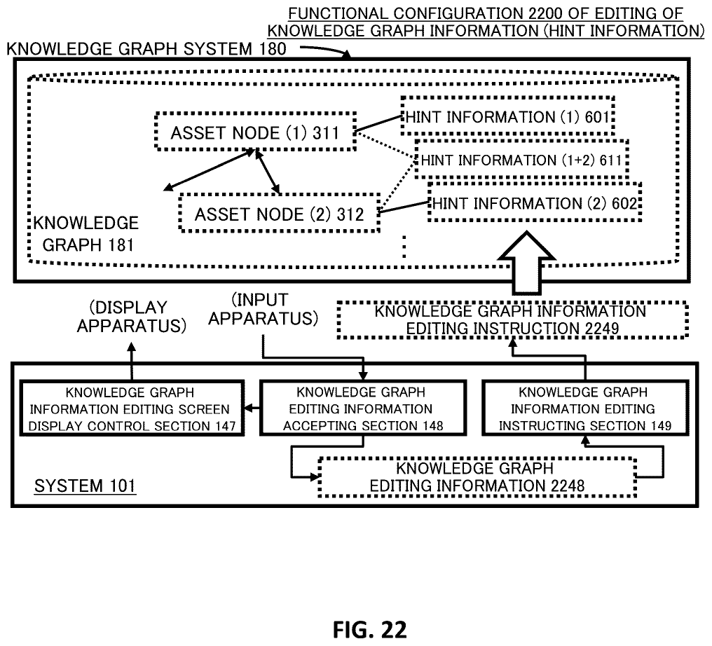

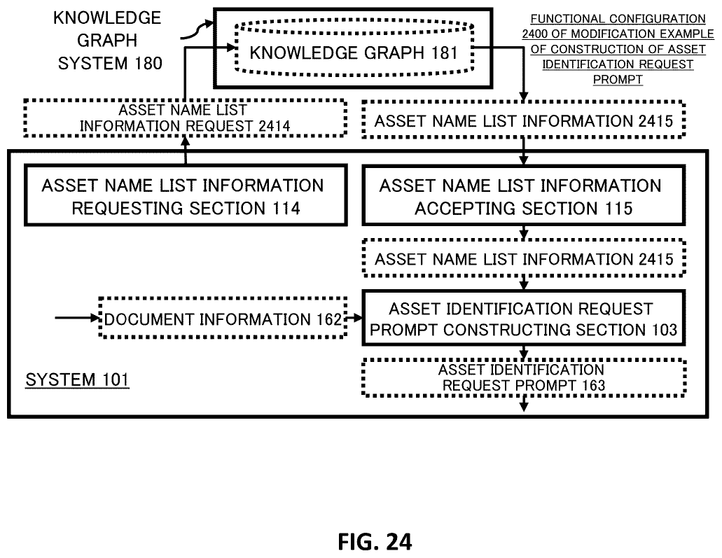

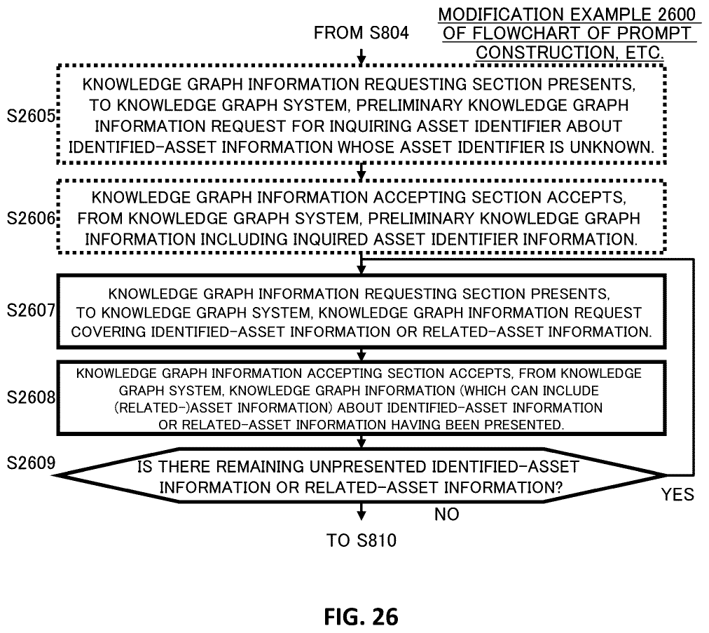

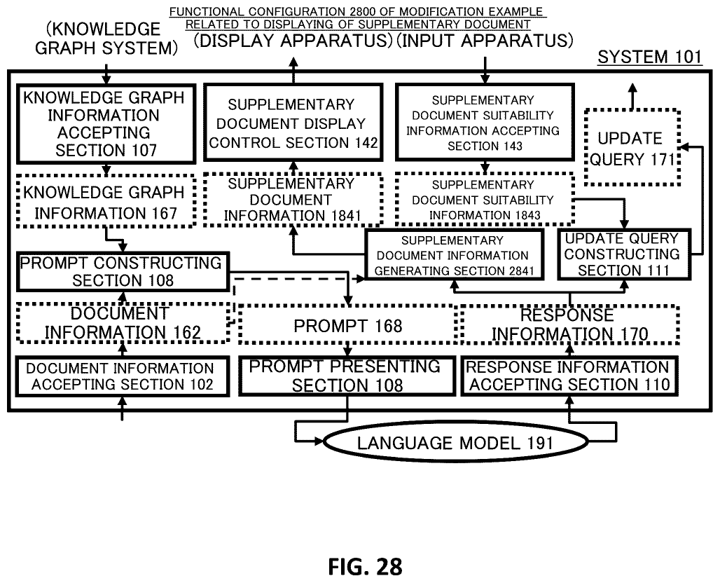

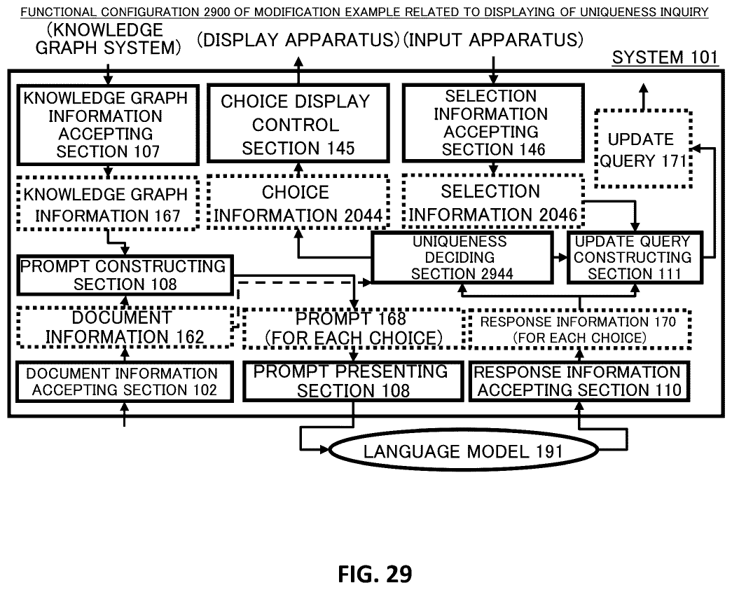

The program group 231 may include each of various types of programs for realizing one of the functional sections expressed as “sections” in a functional configuration diagram or a flowchart depicted in FIG. 1, FIG. 6, FIG. 7, FIG. 8, FIG. 16, FIG. 17, FIG. 18, FIG. 20, FIG. 22, FIG. 24, FIG. 26, FIG. 28, or FIG. 29. Note that some of the programs described above may be integrated into one program. In addition, any one of the programs described above may be divided into a plurality of programs.

The data group 232 may include information (data, etc.) handled by the functional sections described above.

Instead of what has been described above, some or all of the various types of programs included in the program group 231, the various types of data groups included in the data group 232, or the information in the various types of information 233 that are described above is acquired from the outside of the configuration depicted in FIG. 2, in another possible mode.

The external recording medium drive 204 can be connected with an external recording medium 205. For example, the external recording medium 205 may be a portable recording disk (digital versatile disc (DVD), etc.), an integrated circuit (IC) card, a secure digital (SD) card, a non-volatile memory (e.g., a flash memory), or a portable hard disk. Note that the various types of programs included in the program group 231, the various types of data or the like included in the data group 232, or information similar to the information in the various types of information 233 are/is transferred from the external recording medium 205 to the non-volatile recording medium (recording apparatus) 203 or the storage apparatus 202, and stored thereon, in another possible mode. The external recording medium 205 may be used for recording programs or data handled in the system 101. The external recording medium drive 204 and the external recording medium 205 are connected to the system 101 depicted in FIG. 2 via a network, in another possible mode.

The various types of programs included in the program group 231, the various types of data or the like included in the data group 232, or the information in the various types of information 233 may be brought through the communication apparatus 208, the external input/output port 209, the input apparatus 206, and the reading apparatus 210, and recorded or stored on the non-volatile recording medium (recording apparatus) 203 or the storage apparatus 202.

In order for the architecture depicted in FIG. 2 to function as the system 101, each functional section in the system 101, or a portion of each functional section (to execute one process (step) or a series of processes (steps)), the various types of programs included in the program group 231 may be loaded (e.g., from the non-volatile recording medium (recording apparatus) 203) to the storage apparatus 202. The programs after being loaded are denoted by 221 in FIG. 2. Further, the information processing apparatus 201 may execute the programs 221 (by using also the various types of data or the like included in the data group 232 or the information in the various types of information 233 in the non-volatile recording medium (recording apparatus) 203 or the like, as necessary). Execution of the programs 221 realizes functions of the system 101, each functional section in the system 101, or a portion of each functional section (executes one process (step) or a series of processes (steps)). At this time, various types of buffers 223 formed temporarily in the storage apparatus 202 may also be used as appropriate.

### 3. Example of Structure of Knowledge Graph (FIGS. 3 to 5)

Before processes performed by the embodiment of the present disclosure are explained in detail, the following explains an example of the structure of the knowledge graph, which is the target of updating in the present disclosure.

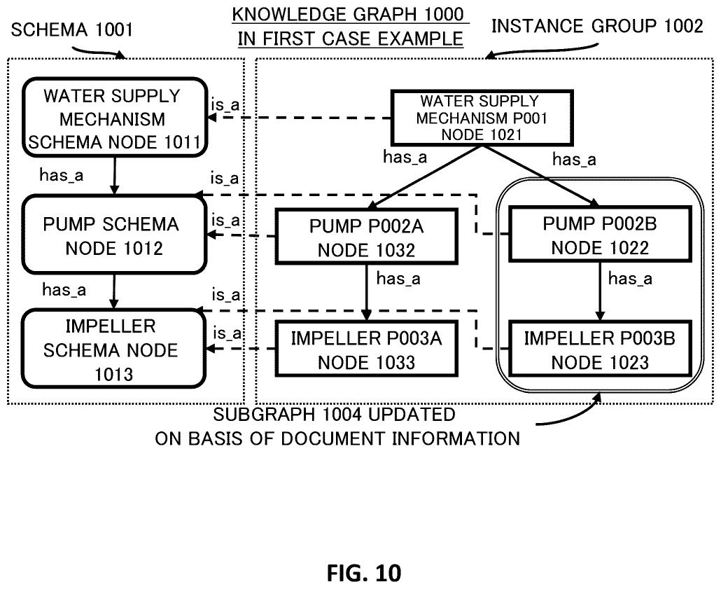

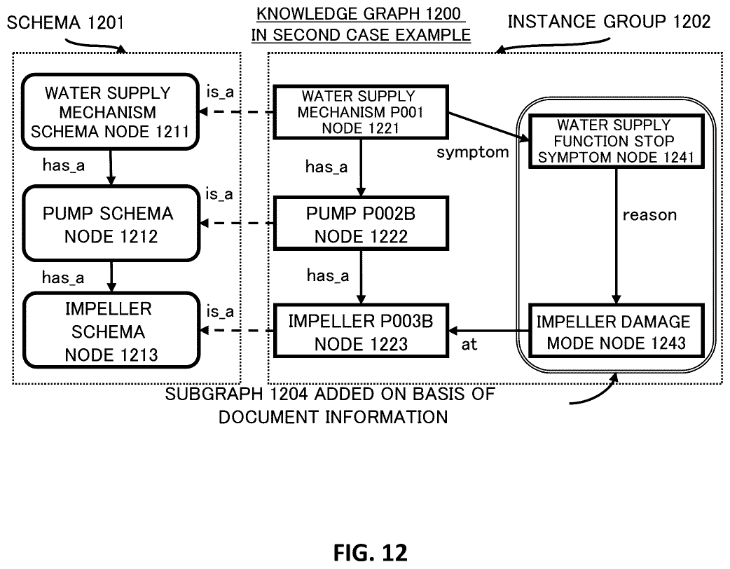

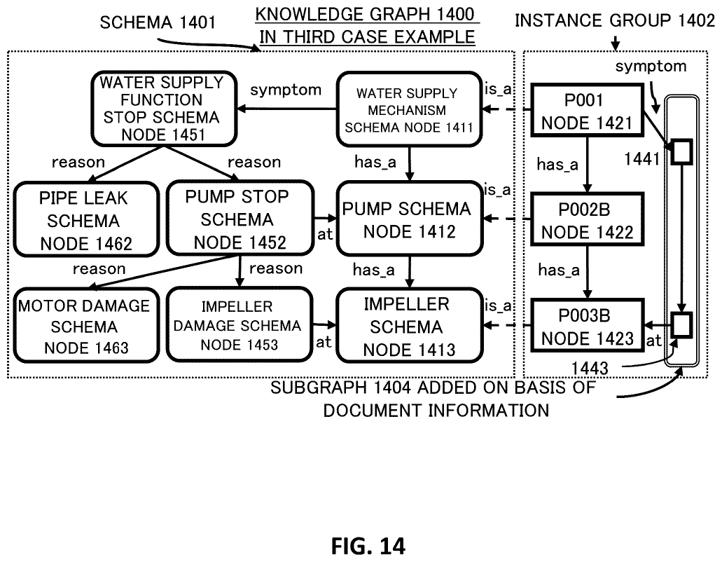

The knowledge graph 181 may include a schema and an instance group. The schema may represent predefinitions of nodes and edges that can be included in the knowledge graph 181 or predefinitions of relations that nodes and edges can have therebetween. For example, the schema may be one like the one depicted in FIG. 10, FIG. 12, or FIG. 14 described later. Meanwhile, the instance group may be one that represents a current condition or the like that is actually recognized about the target (e.g., a facility or an infrastructure) of knowledge represented by the knowledge graph 181. For example, the instance group may be one like the one depicted in FIG. 3, or FIG. 10, FIG. 12, or FIG. 14 described later.

### 3-1. Examples of Types of Nodes and Edges Included in Knowledge Graph

FIG. 3 depicts an example 300 of a structure that the knowledge graph 181 can have. The example depicted in FIG. 3 depicts an instance group 301 representing knowledge about one certain water supply mechanism. Note that, although not depicted in FIG. 3, there may be a schema (e.g., a schema 1401 depicted in FIG. 14) representing predefinitions of nodes and edges included in the instance group 301.

As depicted in FIG. 3, the knowledge graph 181 may include one or more nodes and one or more edges representing the connected relations between nodes. In the example depicted in FIG. 3, the nodes are represented by square frames, and the edges are represented by arrows. (Edges may connect nodes without directionality (non-directional edges).)

In a knowledge graph for representing knowledge about a facility or an infrastructure, there may be asset nodes, symptom nodes, and malfunction mode nodes as the types of nodes.

Asset nodes represent assets (assets, valuables) located in a facility or an infrastructure. In the example depicted in FIG. 3, there are an asset node 311, an asset node 312, and an asset node 313. For example, the asset node 311 may represent a particular water supply mechanism located in a facility or an infrastructure. The asset node 312 may represent a particular pump that the particular water supply mechanism has. The asset node 313 may represent a particular impeller (or motor) that the particular pump has.

The edges between the asset nodes may represent coverage relations (hierarchical relations) like edges of the type “has_a (own)” in FIG. 3. In the example depicted in FIG. 3, the particular water supply mechanism represented by the asset node 311 covers the particular pump represented by the asset node 312. In addition, in the example depicted in FIG. 3, the particular pump represented by the asset node 312 covers the particular impeller represented by the asset node 313. There may be edges of another type as the edges between asset nodes. For example, the connection between assets may be represented by non-directional edges.

Symptom nodes represent symptoms that assets can exhibit. Symptom nodes included in the instance group may represent symptoms that have actually occurred in a past time, symptoms that are actually occurring currently, or symptoms that can occur in a future time in particular assets represented by asset nodes included in the same instance group. (In contrast to this, symptom schema nodes included in the schema may be ones comprehensively predefining symptoms that can occur to assets.) In the example depicted in FIG. 3, a symptom node 314 may represent a symptom, water supply function stop (in the water supply mechanism). In another example, the symptom node 314 may represent a symptom, deteriorated water supply function (in the water supply mechanism). Here, the asset node 311 representing the particular water supply mechanism and the symptom node 314 depicting a symptom of the particular water supply mechanism may be connected to each other by an edge of the type “symptom.” Similarly, in the example depicted in FIG. 3, a symptom node 315 may represent a symptom, pump stop (in the pump) In another example, the symptom node 315 may represent a symptom, lowered delivery amount (in the pump). Here, the asset node 312 representing the particular pump and the symptom node 315 representing a symptom of the particular pump may be connected to each other by an edge of the type “symptom.”

Malfunction mode nodes represent malfunction modes that assets can be in. Malfunction mode nodes included in the instance group may represent malfunction modes that have actually occurred in a past time, malfunction modes that are actually occurring currently, or malfunction modes that can occur in a future time in particular assets represented by asset nodes included in the same instance group. (In contrast to this, malfunction mode schema nodes included in the schema may be ones comprehensively predefining malfunction modes that assets can be in.) In the example depicted in FIG. 3, a malfunction mode node 316 may represent a malfunction mode, impeller damage (in the impeller). Here, the asset node 313 representing the particular impeller and the malfunction mode node 316 representing a malfunction mode of the particular impeller may be connected to each other by an edge of the type “at (location).”

Edges may be set also between symptom nodes and malfunction mode nodes. In the example depicted in FIG. 3, the symptom node 314 representing a symptom of the water supply mechanism and the malfunction mode node 316 representing a malfunction mode of the impeller may be connected to each other by an edge of the type “reason.” For example, an edge of the type “reason” represents that a reason (one of possible reasons) for the symptom, water supply function stop in the water supply mechanism, is the malfunction mode, impeller damage in the impeller that the water supply mechanism has. Similarly, in the example depicted in FIG. 3, the symptom node 315 representing a symptom of the pump and the malfunction mode node 316 representing a malfunction mode of the impeller may be connected to each other by an edge of the type “reason.” For example, an edge of the type “reason” represents that a reason (one of possible reasons) for the symptom, lowered delivery amount in the pump, is the malfunction mode, impeller damage in the impeller that the pump has.

Note that edges of the type “reason” may be set also between symptom nodes and between malfunction mode nodes. In addition, depending on the target (e.g., a facility or an infrastructure) of knowledge represented by the knowledge graph 181, the distinction between whether an event in an asset is recognized as a “symptom” or the event in the asset is recognized as a “malfunction mode” can be unclear. In that case, the knowledge graph 181 may be constructed without making a clear distinction of node types between a symptom node and a malfunction mode node.

As described above, the knowledge graph can include asset nodes/symptom nodes/malfunction mode nodes and edges representing the relations between these nodes (the relations between nodes of the same types, the relations between nodes of different types). Accordingly, regarding one or more elements (e.g., assets) included in the target (e.g., a facility or an infrastructure) represented by the knowledge graph, the knowledge graph can represent specific knowledge including the relations between the elements (assets) and symptoms and malfunction mode that can occur to the elements (assets).

### 3-2. Examples of Node Information and Edge Information

Each of nodes and each of edges included in (the schema or the instance group of) the knowledge graph 181 may accompany a piece of node information which is information about the node or accompany a piece of edge information which is information about the edge. The mode of recording of the node information and the edge information on the recording medium that the knowledge graph system 180 has can be any mode. For example, the node information and the edge information may be recorded in the mode of a table having a record about each of nodes and edges as in FIG. 4 and FIG. 5. Alternatively, the node information and the edge information may be managed on the recording medium that the knowledge graph system 180 has, in a mode in which respective pieces of node information (edge information) related to the same node (edge) are connected with each other by links.

FIG. 4 depicts an example 400 of the node information. FIG. 4 corresponds to an example of the nodes depicted in FIG. 3.

As depicted in FIG. 4, the node information may be recorded in the mode of a table. The table depicted in FIG. 4 may have a record (one row in the table) for each node. One record may have a “node ID” 401 and a “node type/node name” 402, and may also have various types of information. The “node ID” 401 is an identifier that can identify which one in the knowledge graph 181 a node is. In the examples depicted in FIG. 3 and FIG. 4, N1 to N6 are used as “node IDs.” The “node type/node name” 402 represents the type of a node and the name of the node. For example, as the type of a node, the “node type/node name” 402 may be able to identify which of an asset node, a symptom node, and a malfunction mode node the node is. In addition, regarding an asset node, a “node name” may include an asset identifier (P001, P002B, or P003B in the example depicted in FIG. 4). The example depicted in FIG. 4 depicts “various types of information 1” 403 and “various types of information 2” 404 as various types of information included in one record. It should be noted that the number of various types of information included in one record is not restricted.

In the example depicted in FIG. 4, there may be measurement values related to assets as the “various types of information 1” 403 regarding asset nodes with the node IDs N1, N2, and N3. As depicted in FIG. 4, for example, there may be a measurement value x of the water supply capacity value about the water supply mechanism, which is an asset. There may be a measurement value y of the delivery amount and accumulated operating time m about the pump, which is an asset. There may be a measurement value z of the rotation speed and accumulated operating time n about the impeller, which is an asset. Note that there may be various types of information as various types of information about asset nodes. Examples of various types of information about asset nodes (information included in asset node information) are explained later.

In the example depicted in FIG. 4, as the “various types of information 1” 403 about symptom nodes or malfunction mode nodes with the node IDs N4, N5, and N6, there may be determination criteria information for deciding whether or not a node corresponds to a symptom or a malfunction mode. As depicted in FIG. 4, for example, there may be information, “Water supply capacity value<X,” as determination criteria information for deciding that the water supply mechanism has a symptom, lowered water supply capacity. There may be information, “Delivery amount<Y,” as determination criteria information for deciding that the pump has a symptom, lowered delivery amount. There may be information, “Rotation speed<Z,” as determination criteria information for deciding that the impeller is in a malfunction mode, impeller damage. Note that there may be various types of information as various types of information about symptom nodes and malfunction mode nodes.

FIG. 5 depicts an example 500 of edge information. FIG. 5 corresponds to an example of the edges depicted in FIG. 3.

As depicted in FIG. 5, the edge information may be recorded in the mode of a table. The table depicted in FIG. 5 may have a record (one row in the table) for each edge. One record may have an “edge ID” 501, an “edge type” 502, a “FromID” 503, and a “ToID” 504, and may also have various types of information. The “edge ID” 501 is an identifier that can identify which one in the knowledge graph 181 an edge is. In the examples depicted in FIG. 3 and FIG. 5, E1 to E7 are used as “edge IDs.” The “edge type” 502 represents the type of an edge. For example, the type of an edge may be able to identify which of at least “has_a (own),” “symptom,” “reason,” and “at (location)” the type of the edge is. Further, “is_a (instantiate)” may also be able to be identified as the type of an edge. The “FromID” 503 represents an identifier of a node which is the starting point of an edge. The “ToID” 504 represents an identifier of a node which is the end point of the edge. In the example depicted in FIG. 5, regarding an edge with the edge ID E1, the starting point of the edge is the node with the node ID N1, and the end point of the edge is the node with the node ID N2. Note that, in a case where an edge is non-directional, the “FromID” 503 and the “ToID” 504 may represent identifiers of nodes at the two end points that the non-directional edge has. Note that there may be various types of information as various types of information about edges. In addition, various types of information like these may be called edge hint information.

3-3. Information (Asset Node Information) that Asset Nodes can have

Asset nodes for representing knowledge about assets can be associated with various types of node information (asset node information).

A node information group 321 depicted in FIG. 3 represents an example of node information (asset node information) that can be associated with each of asset nodes. For example, the asset node information may be information about asset attributes, information about an asset configuration, node hint information, set-of-hints information, search range information, past document information, or past difference information.

For example, information about asset attributes may be information about specifications (performance or functions) of an asset, information about measurement values in the asset, information about benchmarks related to replacement of the asset, or name variation list information about asset names for coping with writing variations of the asset name. Owing to the existence of information about asset attributes as the asset node information, the knowledge graph can individually and specifically retain knowledge about various attributes related to assets.

For example, information about an asset configuration may be information representing the relation between assets. Note that information representing the relation between assets interconnected by an edge may be represented by a pair of a “FromID” 503 and a “ToID” 504 which are edge information corresponding to the edge, or may be represented by “information about an asset configuration,” which is one piece of asset node information. For example, “information about an asset configuration” which is asset node information about the asset node representing the pump may be information represented by a statement, “The pump includes motor/impeller/coupling.” In addition, “information about an asset configuration” which is asset node information about an asset node on a relatively superordinate layer in the knowledge graph 181 may represent information representing the relation between assets in an asset node group on a relatively subordinate layer. Since the knowledge graph can retain information representing the relations between assets not only as edge information but also as asset node information in this manner, the knowledge graph is flexible regarding the mode of retention of information.

Node hint information is information about the targets (assets in this case) represented by nodes (asset nodes in this case) associated with the node hint information. The node hint information may be any type of information as long as it is information that serves as hints for the language model 191 when the language model 191 generates the response information 170, which is a response to the prompt 168.

For example, “node hint information” which is asset node information about the asset node representing the pump may be information represented by a statement, “Symptoms that can occur to the pump are pump stop/lowered delivery amount/abnormal vibrations.” (The information may be edge information about an edge between an asset node and a symptom node.)

In addition, for example, “node hint information” which is asset node information about the asset node representing either of the pump and the impeller (which are in the coverage relation (hierarchical relation) with each other) may be information represented by a statement, “If the impeller is destroyed, the delivery amount of the pump is lowered.” (The information may be edge information about an edge between the asset node representing the pump and the asset node representing the impeller. Alternatively, the information may be edge information between a symptom node representing a lowered delivery amount and a malfunction mode representing destruction of the impeller.)

Further, for example, “node hint information” which is asset node information about either of two asset nodes that are in a connected relation with each other (that are connected by an edge representing a connected relation with each other) may be information representing the relation between the two assets. (The information may be edge information about an edge between the two asset nodes.)

Moreover, for example, regarding an asset schema node representing the pump and an asset schema node representing a rotor (that are in an inheritance relation with each other (that are connected to each other by an edge representing an inheritance relation with each other)) in the schema, “node hint information” which is asset node information about the asset schema node representing the rotor may be information represented by a statement, “One of malfunction modes of the rotor is abnormal vibrations due to axial misalignment.” (The information may be edge information about an edge between the asset schema node representing the rotor and a malfunction mode schema node representing abnormal vibrations due to axial misalignment.)

Node hint information (including attribute information) may be set not only for asset nodes, but also for symptom nodes or malfunction modes.

Set-of-hints information is information formed by putting together pieces of node information about a plurality of nodes (or pieces of edge information about a plurality of edges). For example, set-of-hints information may be retained as one piece of node information associated with one of the plurality of nodes or a node on a relatively superordinate layer as seen from the plurality of nodes. As described later, a set-of-hints information registration instructing section 113 (see FIG. 6, FIG. 7, and FIG. 8) or a matching information registration instructing section 130 (see FIG. 16 and FIG. 17) in the system 101 may give an instruction for registering set-of-hints information in the knowledge graph 181. Accordingly, initially, at the start of operational use of the knowledge graph 181, set-of-hints information may not be registered in the knowledge graph 181.

Search range information is information specifying, in a case where a node (an asset node in this case) associated with the search range information is a node (a node of an identified asset 182 in this case) specified by a knowledge graph information request 166 (see FIG. 6, FIG. 7, and FIG. 8) described later, the range, including the node, of nodes and edges to be used as the targets of collection of node information (e.g., node hint information) or edge information (e.g., edge hint information). For example, in a case where search range information about a certain node is defined as “two hops,” nodes and edges in the range of “two hops” (the range that can be reached via two edges) with the certain node as the start point may be defined as a search range in response to the knowledge graph information request 166, which will be described later, that identifies the certain node. The knowledge graph system 180 may collect node information and edge information about the nodes and the edges included in the search range, and present the collected information as the knowledge graph information 167 to the knowledge graph information accepting section 107 of the system 101.

Past document information is the document information 162 representing the contents of the document 161 that has triggered updating of the knowledge graph 181 in a past time. The past document information is used at the time of optimization (see FIG. 16 and FIG. 17) of set-of-hints information or the like described later. Note that, in a case where a process of optimizing set-of-hints information or the like is not performed, the knowledge graph system 180 may not retain the past document information.

Past difference information represents the contents (difference information (difference subgraph information) about the knowledge graph 181 obtained before and after updating) of an updating result of the knowledge graph 181 when updating of the knowledge graph 181 has been performed in a past time. The difference information (difference subgraph information) about the knowledge graph 181 obtained before and after updating may include one of or both (1) update information about node information or edge information about a node or an edge having already been in the knowledge graph 181 obtained before updating and (2) information about a node or an edge that has not been in the knowledge graph 181 obtained before updating and has been added after updating. Past document information and past difference information form a pair. That is, one representing a result of updating the knowledge graph 181 on the basis of document information represented by the past document information is the past difference information. In a case where updating of the knowledge graph 181 has been performed a plurality of times in a past time, the knowledge graph system 180 may also record a plurality of pairs of past document information and past difference information. Note that, in a case where a process of optimizing set-of-hints information or the like is not performed, the knowledge graph system 180 may not retain past difference information.

### 4. Processes Performed in Embodiment of Present Disclosure

The following explains processes executed by the embodiment of the present disclosure. Note that it is not essential to realize all functional configurations explained below and perform all the processes explained below. In addition, realization of functional configurations and execution of processes other than the functional configurations and processes explained below are also not precluded.

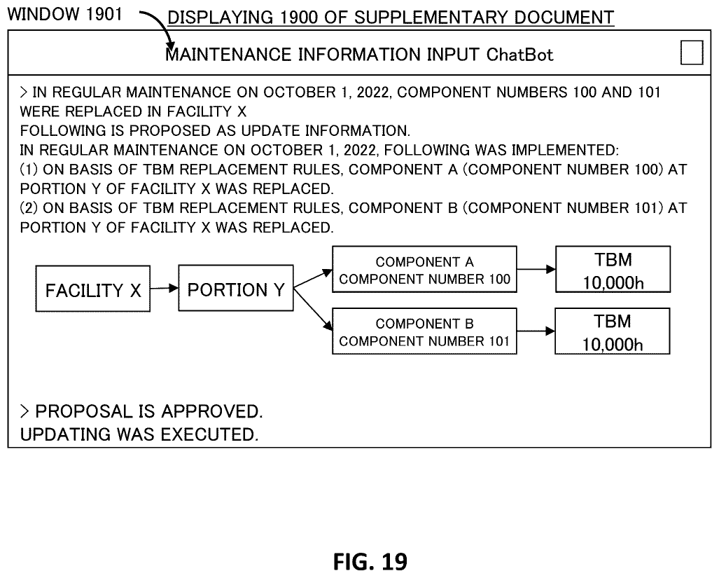

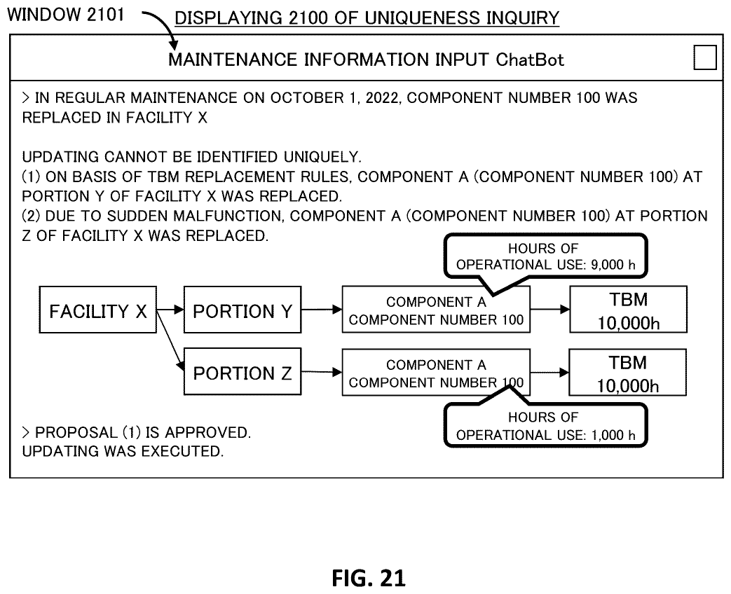

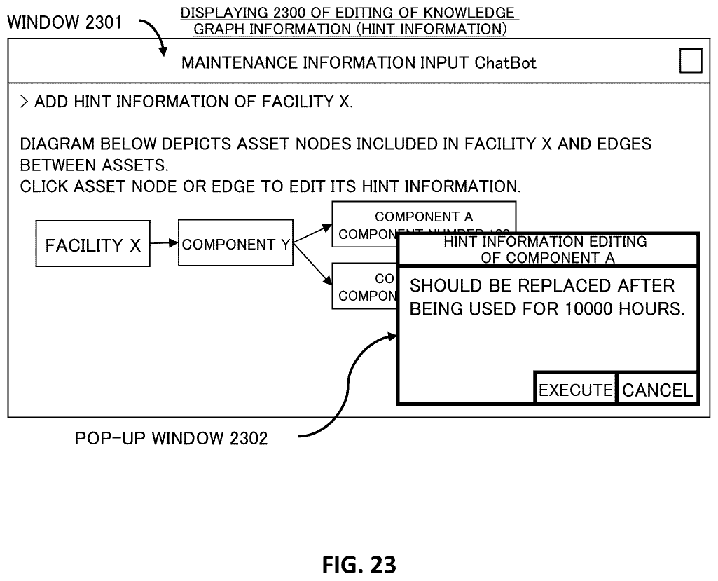

The following explains such processes as prompt construction using knowledge graph information (hint information or set-of-hints information) mainly with reference to FIGS. 6 to 9. Several case examples about a knowledge graph, document information, knowledge graph information, and response information (update query) are explained mainly with reference to FIG. 10 to FIG. 15. A process of optimizing set-of-hints information or the like retained in the knowledge graph 181 is explained mainly with reference to FIG. 16 and FIG. 17. A process of displaying of a supplementary document formed by supplementing or correcting the document information 162 on the basis of the knowledge graph information 167 is explained mainly with reference to FIG. 18 and FIG. 19. A process of displaying for an inquiry about uniqueness of updating, based on the document information 162, of the knowledge graph 181 is explained mainly with reference to FIGS. 20 and 21. A process for editing knowledge graph information (hint information) retained in the knowledge graph 181 is explained mainly with reference to FIG. 22 and FIG. 23.

### 4-1. Such Processes as Prompt Construction Using Knowledge Graph Information (FIGS. 6 to 9)

The basic configuration of the embodiment of the present disclosure involved in the processes ranging from acceptance, by the system 101, of the document information 162 representing the contents of the document 161 that trigger updating of the knowledge graph 181 to updating of the knowledge graph 181 has already been explained with reference to FIG. 1.

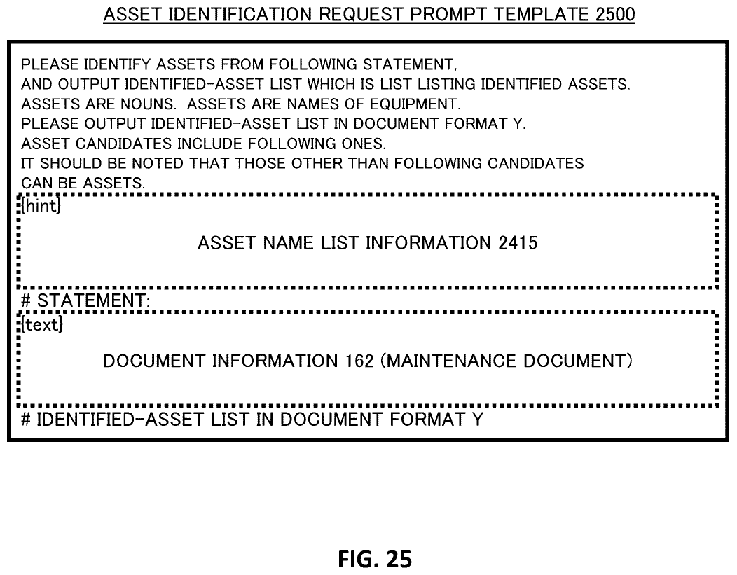

The following explains again processes performed in the embodiment of the present disclosure that range from acceptance, by the system 101, of the document information 162 representing the contents of the document 161 that trigger updating of the knowledge graph 181 to updating of the knowledge graph 181 mainly with reference to FIG. 1, FIG. 3, FIG. 6, FIG. 7, FIG. 9, and FIG. 25 as appropriate, in the order of processing steps included in the flowchart depicted in FIG. 8. In particular, the following explains, in more detail, a process performed until the system 101 accepts the knowledge graph information 167, a process of constructing the prompt 168 depending on the contents of the accepted knowledge graph information 167, and a process of updating performed additionally to the knowledge graph 181 accompanying updating of the knowledge graph 181 intended by the document 161.

Before the explanation of the flowchart depicted in FIG. 8 is started, an outline of the figures related to the following explanation is explained. Since FIG. 1 and FIG. 3 have already been explained, explanation thereof is omitted here.

FIG. 6 depicts the functional configuration of (and information to be handled by) the embodiment of the present disclosure with focus on functional configurations that are used (and information to be handled) until the prompt 168 is constructed in a case where the contents of the knowledge graph information 167 used for the construction of the prompt 168 are one or more pieces of hint information. In FIG. 6, illustrations of functional configurations (and information to be handled) related to processes performed after the prompt 168 is constructed are omitted. (For functional configurations (and information to be handled) related to processes performed after the prompt 168 is constructed, refer to FIG. 1.)

Hereinafter, “hint information” may be any type of information as long as it is information retained in the knowledge graph 181 but not “set-of-hints information” itself explained with reference to FIG. 3. “Hint information” may be node information (other than “set-of-hints information”) about a node included in the knowledge graph 181 or may be edge information about an edge included in the knowledge graph 181. That is, every type of information depicted in FIG. 3, FIG. 4, or FIG. 5 other than “set-of-hints information” can be “hint information.” Note that “hint information” should not be interpreted limitedly only as “node hint information” or “edge hint information” depicted in FIG. 3.

The top section of FIG. 6 depicts one in which information that the knowledge graph 181 has is displayed in a simplified manner. In the top section of FIG. 6, a coverage relation (hierarchical relation) or a connected relation between asset nodes is represented by a double-headed arrow between the asset nodes (the double-headed arrow is not an edge depicted in FIG. 3 itself). Further, the top section of FIG. 6 depicts a state where hint information is associated with each of asset nodes. For example, the asset node (1) 311 is associated with hint information (1) 601, the asset node (2) 312 is associated with hint information (2) 602, and the asset node (3) 313 is associated with hint information (3) 603. In addition, the top section of FIG. 6 depicts a state where hint information is associated with a node set (e.g., a pair of nodes) including a plurality of asset nodes. For example, hint information (1+2) 611 is associated with a node set including the asset node (1) 311 and the asset node (2) 312. In addition, hint information (2+3) 612 is associated with a node set including the asset node (2) 312 and the asset node (3) 313. For example, the hint information (1+2) 611 and the hint information (2+3) 612 may be edge information.

Those in FIG. 6 which have solid-line frames and have “section” in their names are functional sections. Each of the functional sections may be realized by execution of a program or may be realized in a form of hardware. As depicted in FIG. 6, in addition to the functional sections already depicted in FIG. 1, the system 101 may include an asset identification request prompt constructing section 103, an asset identification request prompt presenting section 104, an identified-asset response information accepting section 105, a knowledge graph information requesting section 106, and the set-of-hints information registration instructing section 113. Roles played by these functional sections are explained along with processing steps included in the flowchart depicted in FIG. 8 later.

Those in FIG. 6 which have dotted-line frames represent some information (data). These pieces of information are also explained along with processing steps included in the flowchart depicted in FIG. 8 later.

FIG. 7 depicts the functional configuration of (and information to be handled by) the embodiment of the present disclosure with focus on functional configurations that are used (and information to be handled) until the prompt 168 is constructed in a case where the contents of the knowledge graph information 167 used for the construction of the prompt 168 are set-of-hints information. In FIG. 7, illustrations of functional configurations (and information to be handled) related to processes performed after the prompt 168 is constructed are omitted. (For functional configurations (and information to be handled) related to processes performed after the prompt 168 is constructed, refer to FIG. 1.) In addition, in FIG. 7, illustrations of functional configurations (and information to be handled) related to processes performed before the knowledge graph information requesting section 106 performs a process of presenting the knowledge graph information request 166 to the knowledge graph system 180 are omitted. (For functional configurations (and information to be handled) related to processes performed before the knowledge graph information requesting section 106 performs the process of presenting the knowledge graph information request 166 to the knowledge graph system 180, refer to FIG. 6.)

The embodiment of the present disclosure may have functional configurations depicted in both FIG. 6 and FIG. 7 (in addition to the basic functional configuration depicted in FIG. 1). (Note that there can also be a modification example in which only one of the functional configuration depicted in FIG. 6 that treats hint information and the functional configuration depicted in FIG. 7 that treats set-of-hints information is provided (in addition to the basic functional configuration depicted in FIG. 1).)

The top section of FIG. 7 is similar to the top section of FIG. 6 in that it depicts a mode of the knowledge graph 181. It should be noted that the top section of FIG. 7 depicts the set-of-hints information 701 about the asset node (1) 311. The set-of-hints information 701 is a set of hint information including hint information about a plurality of nodes. That is, the set-of-hints information 701 can include information about nodes other than the asset node (1) 311.

Those in FIG. 7 which have solid-line frames and have “section” in their names are functional sections. Each of the functional sections may be realized by execution of a program or may be realized in a form of hardware. Roles played by these functional sections are explained along with processing steps included in the flowchart depicted in FIG. 8 later.

Those in FIG. 7 having dotted-line frames represent some information (data). These pieces of information are also explained along with processing steps included in the flowchart depicted in FIG. 8 later.

FIG. 9 depicts an example 900 of prompt construction performed by the prompt constructing section 108. As depicted in FIG. 9, for example, the prompt constructing section 108 may insert, to a portion written as {hint} in the prompt template 901, set-of-hints information constructed from one or more pieces of hint information (see FIG. 6) accepted as the knowledge graph information 167 from the knowledge graph system 180 or the set-of-hints information 701 (see FIG. 7) accepted as the knowledge graph information 167 from the knowledge graph system 180. In addition, for example, the prompt constructing section 108 may insert the document information 162 to a portion displayed as {text} in the prompt template 901. The prompt constructing section 108 may construct the prompt 168 by these insertion processes. Note that the technique of constructing the prompt 168 at the prompt constructing section 108 is not limited to that depicted in FIG. 9.

Note that FIG. 9 depicts an example (e.g., a class diagram 970 in a PlantUML format) of the response information 170 which is a response of the language model 191 to which the prompt 168 is input. In this case, for example, “document format X” in FIG. 9 may be “PlantUML format.”

FIG. 9 is also explained later along with processing steps included in the flowchart depicted in FIG. 8.

FIG. 25 depicts an asset identification request prompt template 2500 (although this is one in a modification example explained later). An asset identification request prompt 163 is constructed by inserting asset name list information 2415 (in a modification example described later) to a portion displayed as {hint} in the asset identification request prompt template 2500 and inserting the document information 162 to a portion displayed as {text} in the asset identification request prompt template 2500.

Here, in the asset identification request prompt template for the embodiment depicted in FIG. 6, there may not be the portion displayed as {hint} in FIG. 25 (and the description of two lines immediately before the portion displayed as {hint}).

Note that, for example, a “document format Y” in FIG. 25 may be a “comma-separated values (CSV) format.”

The following explains processing steps included in the flowchart depicted in FIG. 8 in order.

In Step 801 (document information acceptance step) in FIG. 8, the document information accepting section 102 accepts the document information 162. Processes performed by the document information accepting section 102, the document information 162, a system that presents the document information 162, and the like have already been explained using FIG. 1.

In Step 802 in FIG. 8, the asset identification request prompt constructing section 103 constructs the asset identification request prompt 163 on the basis of the document information 162. The asset identification request prompt 163 is for requesting the language model 191 to identify the name of an element (e.g., an asset (asset, valuables)) included in the target (e.g., a facility or an infrastructure) of knowledge represented by the knowledge graph 181 from the contents of the document 161 represented by the document information 162. For example, the asset identification request prompt 163 can be said to be one for requesting the language model 191 to identify the names, “water supply mechanism P001,” “pump P002B,” and “impeller P003B,” of elements (assets) from the document information 162 representing the contents of the document 161 (maintenance document), “In an inspection of the water supply mechanism P001 on Oct. 10, 2022, the impeller P003B of the pump P002B was replaced” illustrated in FIG. 9. The asset identification request prompt constructing section 103 may use the asset identification request prompt template 2500 depicted in FIG. 25 described above or an asset identification request prompt template in a similar format (e.g., a template in a format obtained by omitting the portion related to the asset name list information 2415 from the format depicted in FIG. 25). The asset identification request prompt constructing section 103 may construct the asset identification request prompt 163 by inserting the document information 162 to a relevant portion (e.g., the portion {text} in FIG. 25) in the asset identification request prompt template. (Note that a modification example in which the asset identification request prompt 163 is constructed also on the basis of the asset name list information 2415 in addition to the document information 162 is explained later.)

In Step 803 in FIG. 8, the asset identification request prompt presenting section 104 presents the asset identification request prompt 163 to the language model system 190.

The language model system 190 inputs the presented asset identification request prompt 163 to the language model 191. The language model 191 identifies names that are included in the document information 162 inserted into the asset identification request prompt 163 and are the names of elements (assets) included in the target (e.g., a facility or an infrastructure) of knowledge represented by the knowledge graph 181. The language model 191 outputs a list of the identified name of the elements (assets) as identified-asset response information 164. For example, on the basis of the document information 162 representing the contents of the document 161 (maintenance document), “In an inspection of the water supply mechanism P001 on Oct. 10, 2022, the impeller P003B of the pump P002B was replaced” illustrated in FIG. 9, the language model 191 outputs the identified-asset response information 164 including a list of the names of the elements (asset), “water supply mechanism P001,” “pump P002B,” and “impeller P003B.” Note that, in a case where the format of a list of the names of elements (assets) is pre-specified as in the asset identification request prompt template depicted in FIG. 25, the language model 191 generates (outputs) a list of elements (assets) in accordance with the specified format. Whereas the format is “document format Y” in FIG. 25, for example, the format may be a CSV format. The language model system 190 presents the identified-asset response information 164 to the system 101.

In Step 804 in FIG. 8, the identified-asset response information accepting section 105 accepts the identified-asset response information 164 from the language model system 190. Either of the identified-asset response information accepting section 105 and the knowledge graph information requesting section 106 may treat, as “identified-asset information 165,” each piece of information representing the names of elements (assets) included in the identified-asset response information 164. In the example described above, each of information representing “water supply mechanism P001,” information representing “pump P002B,” and information representing “impeller P003B” may be treated as the identified-asset information 165. In addition, “water supply mechanism P001,” “pump P002B,” and “impeller P003B” may be called “identified assets 182” in the sense that they are elements (assets) identified on the basis of the document information 162.

Since the language model 191 is used for obtaining a list of elements (assets) from the document information 162 as described above, generation of the identified-asset information 165 can be automated.

In Step 807 in FIG. 8, the knowledge graph information requesting section 106 presents the knowledge graph information request 166 to the knowledge graph system 180. The knowledge graph information request 166 includes the identified-asset information 165. The knowledge graph information request 166 makes a request to obtain, as the knowledge graph information 167, knowledge about the identified assets 182 represented by the identified-asset information 165 or knowledge about related assets 183 which are assets related to the identified assets 182 (if any) from knowledge represented by the knowledge graph 181.

The knowledge graph system 180 extracts, from the knowledge graph 181, the knowledge about the identified assets 182 represented by the presented knowledge graph information request 166 and the knowledge about the related assets 183 (if any). The knowledge graph system 180 presents information about the extracted knowledge as the knowledge graph information 167 to the system 101. Although the knowledge about the assets described here is any information depicted in FIG. 3, FIG. 4, or FIG. 5, the knowledge is displayed in a simplified manner by being roughly classified into “hint information (which is any information other than set-of-hints information)” and “set-of-hints information” in FIG. 6 and FIG. 7. In the example described above, each of “water supply mechanism P001,” “pump P002B,” and “impeller P003B” is an identified asset 182. If any, and if necessary, assets like “motor P004B” may be a target of extraction of knowledge as related assets 183.

Here, the technique by which the knowledge graph system 180 specifies related assets 183 may be any technique. For example, the knowledge graph system 180 may determine a search range of the knowledge graph 181 to be adopted when related assets 183 are specified, on the basis of “search range information (search hop count information; see FIG. 3) about any one of the identified assets 182.

In Step 808 (knowledge graph information acceptance step) in FIG. 8, the knowledge graph information accepting section 107 accepts the knowledge graph information 167 from the knowledge graph system 180. The accepted knowledge graph information 167 is roughly classified into (1) one including hint information (group) about the identified assets 182 or the related assets 183 but not including the set-of-hints information 701 and (2) one including the set-of-hints information 701 about any one of the identified assets 182 or the related assets 183.

In Step 810 in FIG. 8, the knowledge graph information accepting section 107 (or the prompt constructing section 108) determines whether the accepted knowledge graph information 167 includes the set-of-hints information 701. In a case where a determination result of Step 810 is YES (in a case where the accepted knowledge graph information 167 includes the set-of-hints information 701), the control may proceed to Step 813. That is, processes in Step 811 and Step 812 may be omitted. In a case where a determination result of Step 810 is NO (in a case where the accepted knowledge graph information 167 does not include the set-of-hints information 701), the control proceeds to Step 811.

Note that FIG. 6 mainly depicts a case where the accepted knowledge graph information 167 does not include the set-of-hints information 701. In contrast, FIG. 7 mainly depicts a case where the accepted knowledge graph information 167 includes the set-of-hints information 701.

In Step 811 in FIG. 8, the knowledge graph information accepting section 107 (or the prompt constructing section 108) constructs set-of-hints information by using the hint information (group) included in the accepted knowledge graph information 167. For example, the set-of-hints information may be constructed in a mode in which each piece of hint information included in the accepted knowledge graph information 167 is listed.

In Step 812 in FIG. 8, the set-of-hints information registration instructing section 113 may present, to the knowledge graph system 180, a set-of-hints information registration instruction 173 (see FIG. 7) for giving an instruction for registering the set-of-hints information constructed in Step 811.

In accordance with the presented set-of-hints information registration instruction 173, the knowledge graph system 180 may register (record) the set-of-hints information constructed in Step 811 in association with a node (e.g., an asset node on a relatively superordinate layer) included in the knowledge graph 181. Accordingly, the set-of-hints information 701 can be automatically registered (recorded) in the knowledge graph 181. Accordingly, it can be expected that opportunities in which the prompt 168 can be constructed efficiently using the set-of-hints information 701 increase.

Note that the set-of-hints information registration instructing section 113 may be not only actuated for automatically registering (recording) the set-of-hints information, but also actuated when there is a manually-made request asking for registration (recording) of set-of-hints information. Accordingly, set-of-hints information which is a product of trial and error by a human can also be registered (recorded) in the knowledge graph 181.

In addition, the processing step depicted as Step 812 in FIG. 8 may be executed at a timing later than the timing depicted in FIG. 8. For example, the processing step depicted as Step 812 may be executed before or after a timing at which Step 818 or Step 819 is performed, which timing is a timing near the end in FIG. 8.

In Step 813 (prompt construction step) in FIG. 8, the prompt constructing section 108 constructs the prompt 168 on the basis of the document information 162 and the knowledge graph information 167. The process performed by the prompt constructing section 108 and the mode of the prompt 168 have already been explained using FIG. 1 or have already been explained using FIG. 9. The following gives some supplementary explanations.

As depicted in FIG. 9, the beginning portion of the prompt template 901 used by the prompt constructing section 108 represents a common request statement to be used when the language model 191 is requested to generate (output) the response information 170 which is information to be used when the update query 171 is constructed in order to update the knowledge graph 181. As depicted in FIG. 9, for example, the beginning portion of the prompt template 901 may represent a request statement, “You are an expert of the document format X. Please construct classes of the document format X by using the following statement, and output a class diagram in the format of the document format X. Please follow the following rules in the class diagram creation.”

In the prompt template 901, the beginning portion may be followed by the portion {hint} into which the knowledge graph information 167 is inserted, the description portion of “#statement:,” the portion {text} into which the document information 162 is inserted, and the description portion of “#class diagram in document format X” (immediately below this portion, the response information 170 from the language model 191 is inserted), in order.

The knowledge graph information 167 inserted into the portion {hint} in the prompt template 901 may be the set-of-hints information constructed at the Step 811 on the basis of one or more pieces of hint information accepted as the knowledge graph information 167 from the knowledge graph system 180 or the set-of-hints information 701 accepted as the knowledge graph information 167 from the knowledge graph system 180. The set-of-hints information depicted in the example depicted in FIG. 9 includes “Water supply mechanism P001, pump P002B, and impeller P003B are assets.,” “The assets have the following relations.,” “water supply mechanism P001→pump P002B,” and “pump P002B→impeller P003B.”

In a case where the set-of-hints information is one constructed in Step 811, individual pieces of hint information included in the set-of-hints information may be retained in association with respective nodes or respective edges in the knowledge graph 181. For example, the portion, “Water supply mechanism P001, pump P002B, and impeller P003B are assets.,” in the set-of-hints information depicted in FIG. 9 may be hint information associated with the asset node representing “water supply mechanism P001,” the asset node representing “pump P002B,” or the asset node representing “impeller P003B.” The portions, “The assets have the following relations.” and “water supply mechanism P001→Pump P002B,” may be hint information associated with an edge connecting the asset node representing “water supply mechanism P001” and the asset node representing “pump P002B.” (Alternatively, the portions may be hint information representing an asset configuration associated with the asset node representing “water supply mechanism P001.”) The portions, “The assets have the following relations.” and “pump P002B→impeller P003B,” may be hint information associated with an edge connecting the asset node representing “pump P002B” and the asset node representing “impeller P003B.” (Alternatively, the portions may be hint information representing an asset configuration associated with the asset node representing “pump P002B.”)

In a case where the set-of-hints information depicted in FIG. 9 is the set-of-hints information 701 accepted as the knowledge graph information 167 from the knowledge graph system 180, for example, the set-of-hints information 701 may be retained by the knowledge graph 181 as one related to the asset node representing “water supply mechanism P001” (on a relatively superordinate layer).

The prompt template 901 may be recorded in a recording medium or a recording apparatus (e.g., the non-volatile recording medium (recording apparatus) 203 in FIG. 2) in the system 101. Alternatively, the prompt template 901 may be recorded in a recording medium or a recording apparatus in the knowledge graph system 180. In that case, in response to a request from the system 101, the knowledge graph system 180 may provide the prompt template 901 to the system 101.

There may be a prompt template for each set of nodes and edges representing knowledge about a facility or an infrastructure in the knowledge graph 181. In that case, for example, a prompt template may be registered (recorded) in association with an asset node on a relatively superordinate layer in the set of nodes and edges.

Alternatively, there may be a different prompt template for each type of the document 161 that triggers modification of the knowledge graph 181. For example, as separate prompt templates, there may be a maintenance prompt template corresponding to a maintenance document created in a maintenance activity for a facility or an infrastructure, a design prompt template corresponding to a design document created in a designing activity for the facility or an infrastructure, and an operational use prompt template corresponding to an operational use document created in an operational use activity of the facility or an infrastructure.

In Step 814 (prompt presentation step) in FIG. 8, the prompt presenting section 109 presents the prompt 168 to the language model system 190.

The language model system 190 inputs the presented prompt 168 to the language model 191. The language model 191 generates (outputs) the response information 170 which is a response to the prompt 168. The language model system 190 presents the response information 170 to the system 101.

The prompt 168 includes not only the document information 162 but also the knowledge graph information 167 (e.g., set-of-hints information). Accordingly, the language model 191 can generate (output) the response information 170 sufficiently taking into account domain knowledge about the target (e.g., a facility or an infrastructure) of knowledge represented by the knowledge graph 181 updated on the basis of the document information 162. In addition, also in a case where the contents of the document 161 depicted in the document information 162 have been subjected to omission or the like, the language model 191 can generate (output) the response information 170 taking into account the supplemented or corrected contents of the document 161.

The lower portion of FIG. 9 depicts an example of the response information 170. Since the prompt template 901 and the prompt 168 request the response information 170 in a mode similar to a class diagram in the document format X (e.g., a PlantUML format) in the example depicted in FIG. 9, the example of the response information 170 depicted in the lower portion of FIG. 9 is the class diagram 970 (or one similar to the class diagram). In the example of the response information 170 depicted in FIG. 9, the class of “water supply mechanism” represents “ID: P001,” the class of “pump” represents “ID: P002B,” the class of “impeller” represents “ID: P003B” and “replacement date: Oct. 10, 2022,” and edges between the asset nodes represent “water supply mechanism→pump: has_a” and “pump→impeller: has_a.”

Note that the format of the response information 170 is not limited to the one described above. For example, the format of the response information 170 may be formats of the response information 170 like the ones depicted in FIG. 11, FIG. 13, and FIG. 15.

In Step 815 (response information acceptance step) in FIG. 8, the response information accepting section 110 accepts the response information 170 from the language model system 190.

In Step 816 (update query construction step) in FIG. 8, the update query constructing section 111 constructs the update query 171 on the basis of the response information 170. The process performed by the update query constructing section 111 and the mode of the update query 171 have already been explained using FIG. 1.

In Step 817 in FIG. 8, an examining section not depicted in FIG. 6 and FIG. 7 (which the system 101 may have) may examine the suitability of the update query 171. For example, the examining section may automatically check whether or not the update query 171 violates constraints or rules of the knowledge graph 181. Alternatively, for example, the examining section may control the display/output apparatus 207 to display or output the update query 171. In this case, the examining section may receive, via the input apparatus 206, an input of a result of determination as to whether the update query 171 is suited or not by a person who views a display result or an output result. In a case where the examining section has obtained a negative examination result regarding the suitability of the update query, the control may return to any of the relatively upstream processing steps in the flowchart depicted in FIG. 8. In a case where the examining section has obtained a positive examination result regarding the suitability of the update query, the control proceeds to Step 818.

Note that, in a case where the suitability of the update query 171 is not to be examined or in a case where it is expected that the suitability of the update query 171 is positive in general, a configuration in which the system 101 does not have the examining section or the system 101 does not execute Step 817 is also tolerated.

In Step 818 (update query presentation step) in FIG. 8, the update query presenting section 112 presents the update query 171 to the knowledge graph system 180. The process performed by the update query presenting section 112 and the process performed by the knowledge graph system 180 to which the update query 171 is presented have already been explained using FIG. 1.

In Step 819 in FIG. 8, a document/difference registration instructing section not depicted in FIG. 6 or FIG. 7 (which the system 101 may have) may present the history registration instruction to the knowledge graph system 180. The history registration instruction is for giving an instruction for registering (recording), in the knowledge graph system 180, the document information 162 accepted in Step 801 and the contents of a result of updating of the knowledge graph 181 performed by the knowledge graph system 180 in Step 818 (difference information (difference subgraph information) about the knowledge graph 181 obtained before and after updating). The document information 162 registered (recorded) in accordance with the history registration instruction becomes the “past document information” depicted in FIG. 3. In addition, the difference information (difference subgraph information) registered (recorded) in accordance with the history registration instruction becomes the “past difference information” depicted in FIG. 3. The “past document information” and the “past difference information” have already been explained using FIG. 3.

When the “past document information” and the “past difference information” are registered (recorded), they may be associated with any one of nodes or edges involved in updating of the knowledge graph 181. For example, the “past document information” and the “past difference information” may be registered (recorded) in association with an asset node on a relatively superordinate layer (e.g., the asset node representing “water supply mechanism” among the respective asset nodes representing “water supply mechanism,” “pump,” and “impeller”).

Note that, in a case where a process of optimizing set-of-hints information or the like depicted in a flowchart depicted in FIG. 17 described later is not performed, the necessity of registering (recording) the “past document information” and the “past difference information” lowers, and accordingly, the process in Step 819 may not be executed.

As described above, in the embodiment of the present disclosure, the prompt 168 can be constructed flexibly depending on the mode of the knowledge graph information 167 accepted by the system 101 after extraction from the knowledge graph 181 has been performed, regarding the identified assets 182 whose names are described in the document 161 represented by the document information 162 and the related assets 183 related to the identified assets 182. Specifically, in a case where the knowledge graph information 167 accepted by the system 101 does not include the set-of-hints information 701 comprehensively representing knowledge about a plurality of nodes and edges in the knowledge graph 181, set-of-hints information is newly constructed from individual pieces of hint information included in the accepted knowledge graph information 167. In contrast, in a case where the knowledge graph information 167 accepted by the system 101 includes the set-of-hints information 701, a processing step of constructing set-of-hints information may be omitted. Further, the prompt 168 is constructed on the basis of the document information 162 and the knowledge graph information 167 (e.g., set-of-hints information).

In addition, even in a case where the knowledge graph information 167 accepted by the system 101 does not include the set-of-hints information 701 comprehensively representing knowledge about a plurality of nodes and edges in the knowledge graph 181, set-of-hints information newly constructed by the system 101 may be registered (recorded) in the knowledge graph 181. Accordingly, when the newly registered (recorded) set-of-hints information is to be used later, construction of the prompt 168 becomes efficient.

### 4-2. Case Examples of Knowledge Graph, Document Information, Knowledge Graph Information, and Response Information (Update Query)

The following explains a first case example, a second case example, and a third case example. Regarding each of the case examples, a combination of a knowledge graph, document information representing the contents of a document that triggers updating of the knowledge graph, knowledge graph information (set-of-hints information and hint information) that can be used for construction of a prompt, and response information (update query) of the language model to the prompt is explained.

The first case example is about a facility in which the water supply mechanism whose identifier is “P001” includes the pump whose identifier is “P002A” and the pump whose identifier is “P002B,” the pump whose identifier is “P002A” includes the impeller whose identifier is “P003A,” and the pump whose identifier is “P002B” includes the impeller whose identifier is “P003B.” Meanwhile, both the second case example and the third case example are about a facility in which the water supply mechanism whose identifier is “P001” includes the pump whose identifier is “P002B” and the pump whose identifier is “P002B” includes the impeller whose identifier is “P003B.”

As depicted in FIG. 10, FIG. 12, and FIG. 14, in any of the case examples, the knowledge graph may include the schema and the instance group. The schema and the instance group have already been explained in the section, “3. Example of structure of knowledge graph.” Note that, in FIG. 10, FIG. 12, and FIG. 14, in order to make distinctions between nodes included in the schema and nodes included in the instance group, the name “schema nodes” is used for the nodes included in the schema.

In any of FIG. 10, FIG. 12, and FIG. 14, asset nodes in coverage relations (hierarchical relations) are connected to each other by edges of the type “has_a (own)” in the schema or in the instance group. Meanwhile, those corresponding to assets of the same types in asset schema nodes in the schema and asset nodes in the instance group may be connected to each other by edges of the type “is_a (instantiate).” For example, a water supply mechanism schema node in the schema and a water supply mechanism node in the instance group may be connected to each other by an edge of the type “is_a (instantiate).” The same applies also to pumps and impellers.

### 4-2-1. First Case Example (FIGS. 10 and 11)

FIG. 10 depicts a knowledge graph 1000 in the first case example. FIG. 10 depicts only asset nodes in nodes included in the knowledge graph. Although not depicted FIG. 10, there may be symptom nodes and malfunction mode nodes. A subgraph 1004 updated on the basis of document information depicted in FIG. 11 in an instance group 1002 depicted in FIG. 10 is represented by being surrounded by a double line in FIG. 10. That is, updating of the knowledge graph in the first case example is of a type that updates information (node information or edge information) about a set of nodes (a set of edges) that are already in the knowledge graph.

FIG. 11 depicts a combination 1100 of document information, knowledge graph information (set-of-hints information and hint information), and response information (update query) in the first case example.

FIG. 11 depicts both a case where updating of the knowledge graph is performed on the basis of document information 162A (maintenance document A) and a case where updating of the knowledge graph is performed on the basis of document information 162B (maintenance document B).

### 4-2-1-1. Case of Document Information 162A (Maintenance Document A)

First, the case of updating the knowledge graph on the basis of the document information 162A (maintenance document A) is explained.

As depicted in the left section of FIG. 11, the document information 162A (maintenance document A) has contents (as a maintenance report), “In an inspection of the water supply mechanism P001 on Oct. 1, 2022, the impeller of the second pump was replaced.” The document information 162A (maintenance document A) includes asset names, “water supply mechanism P001,” “second pump,” and “impeller.”

In the document information 162A (maintenance document A), it is not clear which pump included in “water supply mechanism P001” “second pump” is (it is not clear which identifier is given to “second pump”). In addition, in the document information 162A (maintenance document A), it is not clear which impeller included in “second pump” “impeller” is (it is not clear which identifier is given to “impeller”). Further, in the document information 162A (maintenance document A), it is not clear what type of information in the knowledge graph should be updated along with the fact that “The impeller was replaced.”

In view of the circumstance described above, even if a prompt is constructed on the basis of the document information 162A (maintenance document A) without using the knowledge graph information and the prompt is presented to the language model, the language model that has not been trained with information about a knowledge domain about the knowledge graph is likely to be unable to generate (output) a suitable one as information as a response to the prompt (likely to cause a hallucination (make a mistake)).

In view of this, the system 101 acquires, from the knowledge graph system 180, pieces of knowledge graph information about “water supply mechanism P001,” “second pump,” and “impeller,” which are assets (identified assets) whose names appear in the document information 162A (maintenance document A). The acquired knowledge graph information may be one depicted as “set-of-hints information 1101” in FIG. 11 or may be ones depicted as “hint information 1111,” “hint information 1112,” “hint information 1113,” and “hint information 1114” in FIG. 11. In a case where individual pieces of hint information like “hint information 1111,” “hint information 1112,” “hint information 1113,” and “hint information 1114” are acquired, the set-of-hints information 1101 may newly be constructed using these pieces of hint information.

The hint information 1111 states, “The second pump in P001 is P002B.” The hint information 1111 may be node information about a water supply mechanism P001 node 1021, or may be edge information about an edge (an edge of the type “has_a (own)”) connecting the water supply mechanism P001 node 1021 and a pump P002B node 1022 to each other. The hint information 1112 states, “The impeller of P002B is P003B.” The hint information 1112 may be node information about the pump P002B node 1022, or may be edge information about an edge (an edge of the type “has_a (own)”) connecting the pump P002B node 1022 and an impeller P003B node 1023 to each other. The hint information 1113 states, “Replacement is updating an installation date to a replacement date.” The hint information 1113 may be node information about the water supply mechanism P001 node 1021, may be node information about the pump P002B node 1022, or may be node information about the impeller P003B node 1023. The hint information 1114 states, “In a case where an asset is replaced, subordinate assets thereof are also replaced.” The hint information 1114 may be node information about the water supply mechanism P001 node 1021, or may be node information about the pump P002B node 1022. Note that, in a case where information obtained by combining the hint information 1111, the hint information 1112, the hint information 1113, and the hint information 1114 is registered (recorded) as the set-of-hints information 1101, for example, the set-of-hints information 1101 may be node information about the water supply mechanism P001 node 1021, which is an asset node on a relatively superordinate layer (may be node information about another node).

The knowledge graph information (set-of-hints information and hint information) like the one described above provides knowledge that solves unclarity in the document information 162A (maintenance document A). Specifically, the hint information 1111 clearly represents that the identifier of “second pump” included in the water supply mechanism whose identifier is “P001” is “P002B.” In addition, the hint information 1112 clearly represents that the identifier of the impeller included in the pump (second pump) whose identifier is “P002B” is “P003B.” Further, the hint information 1113 clearly represents that, in a case where an asset (e.g., the impeller) has been replaced, information about “installation date” which is node information about the asset should be updated to match “replacement date” of the asset.

In this manner, owing to the knowledge graph information (set-of-hints information and hint information), it can be expected that a prompt based on the target (e.g., a facility or an infrastructure) of knowledge represented by the knowledge graph is constructed or that a prompt is constructed after matters having been subjected to omission or the like in document information have been supplemented or corrected.

If a prompt with suitable contents is input to the language model, it can be expected that the language model generates (outputs) response information with suitable contents. In the example on the left side of FIG. 11, “The installation date of P003B is updated to Oct. 1, 2022” is obtained as response information 170A. An update query A is constructed on the basis of the response information 170A. The update query A is applied to the knowledge graph.

### 4-2-1-2. Case of Document Information 162B (Maintenance Document B)

Next, the case of updating the knowledge graph on the basis of the document information 162B (maintenance document B) is explained.

As depicted in the right section of FIG. 11, the document information 162B (maintenance document B) has contents (as a maintenance report), “In an inspection of the water supply mechanism P001 on Oct. 1, 2022, the second pump was replaced.” The document information 162B (maintenance document B) includes asset names, “water supply mechanism P001” and “second pump.” The document information 162B (maintenance document B) does not include an asset name “impeller P003B.”

In the document information 162B (maintenance document B), it is not clear which pump included in “water supply mechanism P001” “second pump” is (it is not clear which identifier is given to “second pump”). In addition, since an impeller is included in a pump, in a case where a certain pump is replaced, this also results in implicit replacement of the impeller included in the certain pump, but the document information 162B (maintenance document B) does not mention implicit replacement of the impeller. Further, in the document information 162B (maintenance document B), it is not clear what type of information in the knowledge graph should be updated along with the fact that “The pump was replaced.”

In view of the circumstance described above, even if a prompt is constructed on the basis of the document information 162B (maintenance document B) without using the knowledge graph information and the prompt is presented to the language model, the language model that has not been trained with information about a knowledge domain about the knowledge graph is likely to be unable to generate (output) a suitable one as information as a response to the prompt (likely to cause a hallucination (make a mistake)).

In view of this, by a technique similar to that in the case of the document information 162A (maintenance document A), the system 101 acquires, from the knowledge graph system 180, pieces of knowledge graph information about “water supply mechanism P001” and “second pump,” which are assets (identified assets) whose names appear in the document information 162B (maintenance document B). In addition, in a case where “impeller P003B” is specified as a related asset related to the identified assets, the system 101 may also acquire knowledge graph information about “impeller P003B” from the knowledge graph system 180. The acquired knowledge graph information (set-of-hints information and hint information) may be similar to that acquired in the case of the document information 162A (maintenance document A).

The knowledge graph information (set-of-hints information and hint information) like the one described above provides knowledge that solves unclarity in the document information 162B (maintenance document B). Specifically, the hint information 1111 clearly represents that the identifier of “second pump” included in the water supply mechanism whose identifier is “P001” is “P002B.” In addition, the hint information 1112 clearly represents that the identifier of the impeller included in the pump (second pump) whose identifier is “P002B” is “P003B.” Further, the hint information 1113 clearly represents that, in a case where an asset (e.g., the pump or the impeller) has been replaced, information about “installation date” which is node information about the asset should be updated to match “replacement date” of the asset. Moreover, the hint information 1114 clearly represents that, if an asset (e.g., the pump P002B) on a relatively superordinate layer is replaced, an asset (e.g., the impeller P003B) on a relatively subordinate layer in a coverage relation is also replaced implicitly.

In this manner, owing to the knowledge graph information (set-of-hints information and hint information), it can be expected that a prompt based on the target (e.g., a facility or an infrastructure) of knowledge represented by the knowledge graph is constructed or that a prompt is constructed after matters having been subjected to omission or the like in document information have been supplemented or corrected.

If a prompt with suitable contents is input to the language model, it can be expected that the language model generates (outputs) response information with suitable contents. In the example on the right side of FIG. 11, “The installation date of P002B is updated to Oct. 1, 2022” and “The installation date of P003B is updated to Oct. 1, 2022” are obtained as response information 170B. An update query B is constructed on the basis of the response information 170B. The update query B is applied to the knowledge graph.

### 4-2-2. Second Case Example (FIGS. 12 and 13)

FIG. 12 depicts a knowledge graph 1200 in the second case example. A subgraph 1204 added on the basis of document information depicted in FIG. 13 in an instance group 1202 depicted in FIG. 12 is represented by being surrounded by a double line in FIG. 12. That is, updating of the knowledge graph in the second case example is of a type that adds a subgraph which is a set of nodes (and a set of edges) that has been absent in the knowledge graph obtained before updating.

FIG. 13 depicts a combination 1300 of document information, knowledge graph information (set-of-hints information and hint information), and response information (update query) in the second case example. FIG. 13 depicts a case where updating of the knowledge graph is performed on the basis of document information 162C (maintenance document C).

As depicted in FIG. 13, the document information 162C (maintenance document C) has contents (as a malfunction report), “Water supply function stop of P001. The cause is impeller damage.” The document information 162C (maintenance document C) includes the asset identifier “P001” and the asset name “impeller.” The document information 162C (maintenance document C) does not include the asset name “pump P002B.”

In the document information 162C (maintenance document C), the type of the asset with the identifier “P001” is not clear. In addition, in the document information 162C (maintenance document C), what coverage relation (hierarchical relation) the asset with the identifier “P001” and the asset “impeller” are in is not clear, and the identifier given to “impeller” is not clear.

In view of the circumstance described above, even if a prompt is constructed on the basis of the document information 162C (maintenance document C) without using the knowledge graph information and the prompt is presented to the language model, the language model that has not been trained with information about a knowledge domain about the knowledge graph is likely to be unable to generate (output) a suitable one as information as a response to the prompt (likely to cause a hallucination (make a mistake)).

In view of this, by a technique similar to that in the first case example, the system 101 acquires, from the knowledge graph system 180, pieces of knowledge graph information about “P001” and “impeller,” which are assets (identified assets) whose names and identifiers appear in the document information 162C (maintenance document C). In addition, in a case where “pump P002B” is specified as a related asset related to the identified assets, the system 101 in the embodiment of the present disclosure may also acquire knowledge graph information about “pump P002B” from the knowledge graph system 180. The acquired knowledge graph information may be one depicted as “set-of-hints information 1301” in FIG. 13 or may be ones depicted as “hint information 1311,” “hint information 1312,” “hint information 1313,” and “hint information 1314” in FIG. 13. In a case where individual pieces of hint information like “hint information 1311,” “hint information 1312,” “hint information 1313,” and “hint information 1314” are acquired, the set-of-hints information 1301 may newly be constructed using these pieces of hint information.

The hint information 1311 states, “P001 is a water supply mechanism.” The hint information 1311 may be node information about a water supply mechanism P001 node 1221. The hint information 1312 states, “P001 has P002B.” The hint information 1312 may be node information about the water supply mechanism P001 node 1221, or may be edge information about an edge (an edge of the type “has a (own)”) connecting the water supply mechanism P001 node 1221 and a pump P002B node 1222 to each other. The hint information 1313 states, “P002B has P003B.” The hint information 1313 may be node information about the pump P002B node 1222, or may be edge information about an edge (an edge of the type “has_a (own)”) connecting the pump P002B node 1222 and an impeller P003B node 1223 to each other. The hint information 1314 states, “P003 is an impeller.” The hint information 1314 may be node information about the impeller P003B node 1223. Note that, in a case where information obtained by combining the hint information 1311, the hint information 1312, the hint information 1313, and the hint information 1314 is registered (recorded) as the set-of-hints information 1301, for example, the set-of-hints information 1301 may be node information about the water supply mechanism P001 node 1221, which is an asset node on a relatively superordinate layer (may be node information about another node).

The knowledge graph information (set-of-hints information and hint information) like the one described above provides knowledge that solves unclarity in the document information 162C (maintenance document C). Specifically, the hint information 1311 clearly represents that the type of the asset with the identifier “P001” is “water supply mechanism.” In addition, information obtained by combining the hint information 1312, the hint information 1313, and the hint information 1314 clearly represents that the asset with the identifier “P001” has the asset with the identifier “P002B” and that the asset with the identifier “P002B” has the impeller with the identifier “P003B.”

In this manner, owing to the knowledge graph information (set-of-hints information and hint information), it can be expected that a prompt based on the target (e.g., a facility or an infrastructure) of knowledge represented by the knowledge graph is constructed or that a prompt is constructed after matters having been subjected to omission or the like in document information have been supplemented or corrected.

If a prompt with suitable contents is input to the language model, it can be expected that the language model generates (outputs) response information with suitable contents. In the example depicted in FIG. 13, “The following relations are added:” and “P001→water supply function stop→impeller damage→P003B” are obtained as response information 170C. An update query C is constructed on the basis of the response information 170C. The update query C is applied to the knowledge graph. As a result of application of the update query C to the knowledge graph, as depicted in FIG. 12, a water supply function stop node 1241 and an impeller damage mode node 1243 are added to the instance group 1202, after which the water supply mechanism P001 node 1221 and the water supply function stop node 1241 are connected to each other by an edge of the type “symptom,” the water supply function stop node 1241 and the impeller damage mode node 1243 are connected to each other by an edge of the type “reason,” and the impeller damage mode node 1243 and the impeller P003B node 1223 are connected to each other by an edge of the type “at (location).”

### 4-2-3. Third Case Example (FIGS. 14 and 15)

FIG. 14 depicts a knowledge graph 1400 in the third case example. A subgraph 1404 added on the basis of document information depicted in FIG. 15 in an instance group 1402 depicted in FIG. 14 is represented by being surrounded by a double line in FIG. 14. That is, updating of the knowledge graph in the third case example is of a type that adds a subgraph which is a set of nodes (and a set of edges) that has been absent in the knowledge graph obtained before updating.

The instance group 1402 in FIG. 14 and the instance group 1202 in FIG. 12 have similar nodes and edges included in the instance groups (except that nodes and edges in FIG. 14 are given four digits as reference numerals with the first two digits which are different from the first two digits of four digits given to nodes and edges in FIG. 12). Accordingly, in FIG. 14, the inside of the instance group 1402 is depicted in a simplified manner.

FIG. 14 depicts that the schema 1401 has not only a water supply mechanism schema node 1411, a pump schema node 1412, and an impeller schema node 1413, which are schema nodes related to assets, but also a water supply function stop schema node 1451, a pump stop schema node 1452, a pipe leak schema node 1462, an impeller damage schema node 1453, and a motor damage schema node 1463, which are schema nodes related to symptoms or malfunction modes. The schema 1401 may represent every possible relation about assets/symptoms/malfunction modes comprehensively as much as possible. Meanwhile, the instance group 1402 may represent the relations about assets/symptoms/malfunction modes that exist in reality or that are likely to be going to exist at the target (e.g., a facility or an infrastructure) of knowledge represented by the knowledge graph.

FIG. 15 depicts a combination 1500 of document information, knowledge graph information (set-of-hints information and hint information), and response information (update query) in the third case example. FIG. 15 depicts a case where updating of the knowledge graph is performed on the basis of document information 162D (maintenance document D).

As depicted in FIG. 15, the document information 162D (maintenance document D) has contents (as a maintenance report), “On Oct. 1, 2022, there was a notification of a water supply function stop of P001.” and “On Oct. 2, 2022, the impeller of the second pump of P001 was replaced.” The document information 162D (maintenance document D) includes the asset identifier “P001” and the asset names “second pump” and “impeller.”

In the document information 162D (maintenance document D), the type of the asset with the identifier “P001” is not clear. In addition, in the document information 162D (maintenance document D), it is not clear which pump included in the assets with the identifier “P001” “second pump” is (it is not clear which identifier is given to “second pump”). Further, in the document information 162D (maintenance document D), it is not clear which impeller included in “second pump” “impeller” is (it is not clear which identifier is given to “impeller”). Further, in the document information 162D (maintenance document D), the relation between an occurrence of “water supply function stop” and that “The impeller was replaced” is not clear.

In view of the circumstance described above, even if a prompt is constructed on the basis of the document information 162D (maintenance document D) without using the knowledge graph information and the prompt is presented to the language model, the language model that has not been trained with information about a knowledge domain about the knowledge graph is likely to be unable to generate (output) a suitable one as information as a response to the prompt (likely to cause a hallucination (make a mistake)).

In view of this, by a technique similar to that in the first case example, the system 101 acquires, from the knowledge graph system 180, pieces of knowledge graph information about “P001,” “second pump,” and “impeller,” which are assets (identified assets) whose names and identifiers appear in the document information 162D (maintenance document D). The system 101 may further acquire, from the knowledge graph system 180, knowledge graph information also from each of schema nodes in the schema 1401, regarding “water supply mechanism” as the type of the asset corresponding to “P001,” “pump” as the type of the asset corresponding to “second pump,” and “impeller” as the type of the asset. At this time, targets of acquisition of knowledge graph information may be not only schema nodes (asset schema nodes) related to assets in the schema 1401, but also schema nodes related to symptoms or malfunction modes directly or indirectly connected with the asset schema nodes by edges. The acquired knowledge graph information may be one depicted as “set-of-hints information 1501” in FIG. 15 or may be ones depicted as “hint information 1511,” “hint information 1512,” “hint information 1513,” “hint information 1514,” and “hint information 1515” in FIG. 15. In a case where individual pieces of hint information like “hint information 1511,” “hint information 1512,” “hint information 1513,” “hint information 1514,” and “hint information 1515” are acquired, the set-of-hints information 1501 may newly be constructed using these pieces of hint information.

The hint information 1511 states, “The second pump in P001 is P002B.” The hint information 1511 may be node information about a water supply mechanism P001 node 1421, or may be edge information about an edge (an edge of the type “has_a (own)”) connecting the water supply mechanism P001 node 1421 and a pump P002B node 1422 to each other. The hint information 1512 states, “The impeller of P002B is P003B.” The hint information 1512 may be node information about the pump P002B node 1422, or may be edge information about an edge (an edge of the type “has_a (own)”) connecting the pump P002B node 1422 and an impeller P003B node 1423 to each other. The hint information 1513 states, “Causes of a water supply function stop are a pump stop and a pipe leak.” The hint information 1513 may be node information about the water supply function stop schema node 1451, may be edge information about an edge (an edge of the type “has_a (own)”) connecting the water supply function stop schema node 1451 and the pump stop schema node 1452 to each other, or may be edge information about an edge (an edge of the type “reason”) connecting the water supply function stop schema node 1451 and the pipe leak schema node 1462 to each other. The hint information 1514 states, “Causes of a pump stop are impeller damage and motor damage.” The hint information 1514 may be node information about the pump stop schema node 1452, may be edge information about an edge (an edge of the type “reason”) connecting the pump stop schema node 1452 and the impeller damage schema node 1453 to each other, or may be edge information about an edge (an edge of the type “reason”) connecting the pump stop schema node 1452 and the motor damage schema node 1463 to each other. The hint information 1515 states, “Impeller damage is handled with impeller replacement.” The hint information 1515 may be node information about the impeller damage schema node 1453. Note that, in a case where information obtained by combining the hint information 1511, the hint information 1512, the hint information 1513, the hint information 1514, and the hint information 1515 is registered (recorded) as the set-of-hints information 1501, for example, the set-of-hints information 1501 may be node information about the water supply mechanism P001 node 1421, which is an asset node on a relatively superordinate layer (may be node information about another node).

The knowledge graph information (set-of-hints information and hint information) like the one described above provides knowledge that solves unclarity in the document information 162D (maintenance document D). Specifically, the hint information 1511 clearly represents that the type of the asset with the identifier “P001” is “water supply mechanism,” and clearly represents that the identifier of “second pump” included in the water supply mechanism with the identifier “P001” is “P002B.” In addition, the hint information 1512 clearly represents that the identifier of the impeller included in the pump (second pump) whose identifier is “P002B” is “P003B.” Further, information obtained by combining the hint information 1513, the hint information 1514, and the hint information 1515 clearly represents that one of the expected causes of a water supply function stop is a pump stop, one of the expected causes of the pump stop is impeller damage, and one of the measures (solutions) for the impeller damage is impeller replacement. That is, information obtained by combining the hint information 1513, the hint information 1514, and the hint information 1515 represents the relation between the symptom, which is water supply function stop in the water supply mechanism, and the measure (solution), which is impeller replacement.

In this manner, owing to the knowledge graph information (set-of-hints information and hint information), it can be expected that a prompt based on the target (e.g., a facility or an infrastructure) of knowledge represented by the knowledge graph is constructed or that a prompt is constructed after matters having been subjected to omission or the like in document information have been supplemented or corrected.

If a prompt with suitable contents is input to the language model, it can be expected that the language model generates (outputs) response information with suitable contents. In the example depicted in FIG. 15, “The following relations are added:” and “P001→water supply function stop→impeller damage→P003B” are obtained as response information 170D. An update query D is constructed on the basis of the response information 170D. The update query D is applied to the knowledge graph. As a result of application of the update query D to the knowledge graph, as depicted in FIG. 14 (since the instance group 1402 is depicted in a simplified manner in FIG. 14, also refer to FIG. 12), a water supply function stop node 1441 and an impeller damage mode node 1443 are added to the instance group 1402, after which the water supply mechanism P001 node 1421 and the water supply function stop node 1441 are connected to each other by an edge of the type “symptom,” the water supply function stop node 1441 and the impeller damage mode node 1443 are connected to each other by an edge of the type “reason,” and the impeller damage mode node 1443 and the impeller P003B node 1423 are connected to each other by an edge of the type “at (location).”

### 4-3. Process of Optimizing Set-of-Hints Information and the Like (FIGS. 16 and 17)

As represented by the set-of-hints information registration instructing section 113 in FIG. 6 or FIG. 7, the set-of-hints information registration instruction 173 in FIG. 7, Step 811 in FIG. 8, or Step 812 FIG. 8, in a case where set-of-hints information is newly constructed for construction of the prompt 168, the embodiment of the present disclosure can register (record) the set-of-hints information in the knowledge graph 181. In addition, a person who handles the system 101 and the knowledge graph system 180 can also manually register (record) set-of-hints information constructed by trial and error in the knowledge graph 181.

However, entire hint information included in the set-of-hints information 701 registered (recorded) in the knowledge graph 181 by the technique described above does not necessarily contribute to construction of the update query 171 with appropriate contents. That is, hint information included in the set-of-hints information 701 can also include wasteful hint information or less useful hint information. If the set-of-hints information 701 includes wasteful hint information or less useful hint information, it is possible that the amount of data of the set-of-hints information 701 or information (e.g., the prompt 168) constructed using the set-of-hints information 701 becomes enormous, a bandwidth and communication time at the time of communication of the set-of-hints information 701 or the information constructed using the set-of-hints information 701 become enormous, and computational resources and computation time required for the set-of-hints information 701 or the information constructed using the set-of-hints information 701 become enormous.

In view of this, the following explains a process that can be executed by the embodiment of the present disclosure to optimize the set-of-hints information 701 or the like to be registered (recorded) in the knowledge graph 181. By performing optimization of the set-of-hints information 701 or the like, it can be expected that the amount of data, the bandwidth, the communication time, the required computational resources, the required computation time, and the like related to the set-of-hints information 701 and the information (e.g., the prompt 168) constructed using the set-of-hints information 701 become suitable ones.

FIG. 16 depicts a functional configuration 1600 related to the process of optimizing the set-of-hints information or the like. Although FIG. 16 does not clearly depict boundary lines regarding the system 101, the system 101 may have each of functional sections (represented by solid-line rectangular frames) excluding the knowledge graph system 180 and the language model 191 (illustration of the language model system 190 is omitted) in FIG. 16.

As depicted in FIG. 16, in addition to the functional sections having already been explained, the system 101 may have a knowledge graph update history accepting section 121, a hint information group accepting section 122, a temporary set-of-hints forming section 123, a temporary difference information identifying section 124, a degree-of-similarity calculating section 125, a matching set-of-hints information identifying section 126, and the matching information registration instructing section 130. In addition, there may be an evaluation value processing section 128 (including a function 127) and an other-function control section 129 as functional sections included in the matching set-of-hints information identifying section 126. Functions that each of the functional sections has and processes to be performed by each of the functional sections are explained along with processing steps in the flowchart depicted in FIG. 17.

Dotted-line rectangular frames in FIG. 16 represent some information (data). In addition to the information (data) having already been explained, the system 101 may handle some or all of past document information 1601, past difference information 1602, a hint information group 1603, temporary set-of-hints information 1623, a temporary prompt 1608, temporary response information 1610, temporary difference information 1624, a degree of similarity 1625, hint information count information 1641, temporary search range information 1644, an evaluation value 1627, matching set-of-hints information 1633, matching search range information 1634, and a matching information registration instruction 1630. Meanings of these pieces of information (data) and handling of these pieces of information (data) are explained along with processing steps in the flowchart depicted in FIG. 17.

FIG. 17 depicts a flowchart 1700 of the process of optimizing the set-of-hints information or the like. The following sequentially explains processing steps depicted in FIG. 17 with reference to FIG. 16.

In Step 1701 in FIG. 17, the knowledge graph update history accepting section 121 accepts the past document information 1601 and the past difference information 1602 from the knowledge graph system 180. The explanation using FIG. 3 and the explanation about Step 819 in FIG. 8 have already explained the past document information and the past difference information. In Step 1701, the knowledge graph update history accepting section 121 may accept one pair (pair) of the mutually-associated past document information 1601 and past difference information 1602.

Note that the past difference information 1602 in a pair (pair) of the past document information 1601 and the past difference information 1602 may represent contents of updating in the past of the knowledge graph 181, the updating being based on the update query 171 constructed by collaboration of the system 101 and the language model 191, on the basis of the past document information 1601. Alternatively, the past difference information 1602 may represent contents of updating in the past of the knowledge graph 181, the updating being based on an update query created manually, on the basis of the past document information 1601.

In Step 1702 in FIG. 17, the hint information group accepting section 122 accepts the hint information group 1603 including one or more pieces of hint information from the knowledge graph system 180. The one or more pieces of hint information included in the hint information group 1603 may be information or knowledge (other than set-of-hints information) included in a range of a node group or an edge group represented by the past document information 1601 or the past difference information 1602 as an updating or addition target. Alternatively, a range of a node group or an edge group which is a target of collection of hint information in Step 1702 may be greater than a range of a node group or an edge group directly represented by the past document information 1601 or the past difference information 1602 as an updating or addition target. Moreover, individual pieces of hint information may be extracted from set-of-hints information registered (recorded) in the knowledge graph system 180, and each of the extracted pieces of hint information may then be included in the hint information group 1603.

The loop of processing steps from Step 1703 to Step 1710 in FIG. 17 may be controlled by the other-function control section 129 included in the matching set-of-hints information identifying section 126. While processes included in the loop are executed, the other-function control section 129 may control repeated execution of processes at the temporary set-of-hints forming section 123, the prompt constructing section 108, the prompt presenting section 109, the response information accepting section 110, the temporary difference information identifying section 124, the degree-of-similarity calculating section 125, and the evaluation value processing section 128.

In Step 1703 in FIG. 17, the temporary set-of-hints forming section 123 chooses one or more pieces of hint information from the hint information group 1603, and forms (constructs) the temporary set-of-hints information 1623 by using the chosen hint information. Step 1703 is also typically executed repeatedly along with repetition of the loop of the processing steps from Step 1703 to Step 1710. Every time Step 1703 is executed, the combination of hint information to be included in the temporary set-of-hints information 1623 changes. When the temporary set-of-hints forming section 123 specifies the combination of a set of hints to be included in the temporary set-of-hints information 1623, for example, it may be based on reinforcement learning reflecting results of iteration having already been executed for the loop of the processing steps from Step 1703 to Step 1710. Alternatively, when the temporary set-of-hints forming section 123 specifies the combination of a set of hints to be included in the temporary set-of-hints information 1623, for example, it may be based on a genetic algorithm reflecting results of iteration having already been executed for the loop. Alternatively, the temporary set-of-hints forming section 123 may use a certain optimization technique other than reinforcement learning or a genetic algorithm to specify the combination of a set of hints to be included in the temporary set-of-hints information 1623 every time Step 1703 is executed.

In Step 1704 in FIG. 17, the prompt constructing section 108 constructs the temporary prompt 1608 on the basis of the past document information 1601 and the temporary set-of-hints information 1623. Details of the process performed by the prompt constructing section 108 have already been explained. Explanation of the process performed by the prompt constructing section 108 in Step 1704 is equivalent to one obtained by replacing “document information,” “knowledge graph information” or “set-of-hints information,” and “prompt” in the explanation about the prompt constructing section 108 having already been given with “past document information,” “temporary set-of-hints information,” and “temporary prompt,” respectively. Step 1704 is also typically executed repeatedly along with repetition of the loop of the processing steps from Step 1703 to Step 1710. Since the combination of hint information to be included in the temporary set-of-hints information 1623 differs every time Step 1704 is executed, the temporary prompt 1608 constructed in Step 1704 also differs every time Step 1704 is executed.

In Step 1705 in FIG. 17, the prompt presenting section 109 presents the temporary prompt 1608 to the language model system 190. The language model system 190 inputs the presented temporary prompt 1608 to the language model 191. The language model 191 generates (outputs) the temporary prompt 1608 which is a response to the temporary response information 1610. The language model system 190 presents the temporary response information 1610 to the system 101. Note that the temporary response information 1610 may be in a mode similar to that of the response information 170 having already been explained.

In Step 1706 in FIG. 17, the response information accepting section 110 accepts the temporary response information 1610 from the language model system 190.

In Step 1707 in FIG. 17, the temporary difference information identifying section 124 identifies (generates) the temporary difference information 1624. The temporary difference information 1624 represents differences generated to the knowledge graph 181 in a case where it is assumed that a temporary update query based on the temporary response information 1610 is constructed and it is assumed that the temporary update query is applied to the knowledge graph 181. The differences described here may mean differences resulting from updating of information (node information or edge information) about nodes or edges that are already in the knowledge graph 181 before the temporary update query is applied or may mean differences resulting from addition of nodes or edges that have not been in the knowledge graph 181 before the temporary update query is applied. Differences like these may also be called a difference subgraph.

The temporary difference information identifying section 124 may identify (generate) the temporary difference information 1624 by analyzing the contents of the temporary response information 1610. At this time, the temporary difference information identifying section 124 may accept, from the knowledge graph system 180, information or knowledge about an update-target range (node group or edge group) in the knowledge graph 181 in a case where it is assumed that the temporary update query that can be constructed on the basis of the temporary difference information 1624 is applied to the knowledge graph 181.

Alternatively, the temporary difference information identifying section 124 may request the update query constructing section 111 to construct the temporary update query, and request the update query presenting section 112 to present the temporary update query to the knowledge graph system 180. It should be noted that the temporary difference information identifying section 124 may accept, from the knowledge graph system 180, the temporary difference information 1624 representing an assumed updating result that is obtained in a case where it is assumed that the knowledge graph 181 is updated on the basis of the temporary update query, instead of actual updating of the knowledge graph 181 along with execution of Step 1707.

In Step 1708 in FIG. 17, the degree-of-similarity calculating section 125 calculates the degree of similarity 1625. The degree of similarity 1625 is the degree of similarity between the differences (difference subgraph, etc.), in the knowledge graph 181, represented by the temporary difference information 1624, and differences (difference subgraph, etc.) represented by the past difference information 1602.

For example, in a case where differences in the knowledge graph 181 mean differences resulting from addition of nodes or edges (addition of a difference subgraph) that have not been in the knowledge graph 181 obtained before updating, the degree of similarity 1625 may be a topology degree of similarity between the difference subgraph represented by the temporary difference information 1624 and a difference subgraph represented by the past difference information 1602.

In addition, for example, in a case where differences in the knowledge graph 181 mean differences resulting from updating of information (node information or edge information) about nodes or edges that have been in the knowledge graph 181 obtained before updating, the degree of similarity 1625 may represent the matching rate of information about update targets obtained as a result of collation between a list of information about update targets represented by the temporary difference information 1624 and a list of information about update targets represented by the past difference information 1602.

In Step 1709 in FIG. 17, the evaluation value processing section 128 calculates the evaluation value 1627. The evaluation value 1627 may be calculated on the basis of at least the degree of similarity 1625.

As has already been described, there is a problem with optimization of set-of-hints information or the like that it is desired to prevent wasteful hint information or less useful hint information from being included in set-of-hints information as much as possible. The problem described above can be solved if “slim” temporary set-of-hints information 1623 which is temporary set-of-hints information 1623 with a smaller number of included pieces of hint information, for example, is selected as optimized set-of-hints information (matching set-of-hints information 1633) from the temporary set-of-hints information 1623 that can realize the temporary difference information 1624 with a tolerable degree of similarity with the past difference information 1602.

In view of this, the evaluation value processing section 128 may calculate the evaluation value 1627 by using the function 127 based on both the degree of similarity 1625 and an attribute value related to the temporary set-of-hints information 1623. For example, the attribute value related to the temporary set-of-hints information 1623 described here may be one of or both the hint information count information 1641 representing the number of pieces of hint information included in the temporary set-of-hints information 1623 and the temporary search range information 1644 (temporary search hop count information) representing a search range in a case where hint information included in the temporary set-of-hints information 1623 is collected in the knowledge graph 181 (e.g., a range that can be covered with a predetermined node hop count as counted from a certain node as the start point). In addition, the function 127 may increase the evaluation value 1627 as the degree of similarity 1625 increases and lower the evaluation value 1627 as the number of pieces of hint information represented by the hint information count information 1641 increases or may lower the evaluation value 1627 as the search range represented by the temporary search range information 1644 expands (as the search node hop count increases).

In Step 1710 in FIG. 17, the other-function control section 129 determines whether the evaluation value 1627 satisfies a predetermined condition. For example, the other-function control section 129 determines whether the evaluation value 1627 is greater than a predetermined threshold (or is equal to or greater than a predetermined threshold). If a determination result of Step 1710 is YES, the control proceeds to Step 1711 with the temporary set-of-hints information 1623 at this time being determined as the matching set-of-hints information 1633. If the determination result of Step 1710 is NO, the control returns to Step 1703, new temporary set-of-hints information 1623 is formed, and the processing steps from Step 1703 to Step 1709 are then executed newly.

Note that FIG. 17 depicts an algorithm that finds, in a search-like manner, temporary set-of-hints information 1623 whose evaluation value 1627 satisfies the predetermined condition. Instead of this, it may be premised that a predetermined number of pieces of temporary set-of-hints information 1623 is formed, Step 1703 to Step 1709 may be executed for each of the formed pieces of temporary set-of-hints information 1623, the evaluation value 1627 may be calculated for each of the formed pieces of temporary set-of-hints information 1623, and temporary set-of-hints information 1623 that gives a relatively high (e.g., the highest) evaluation value 1627 may then be determined as the matching set-of-hints information 1633.

In Step 1711 in FIG. 17, the matching information registration instructing section 130 presents the matching information registration instruction 1630 to the knowledge graph system 180. The matching information registration instruction 1630 is for making a request for registration (recording) of the matching set-of-hints information 1633 as the set-of-hints information 701 or registration (recording) of the matching search range information 1634 as search range information. The matching set-of-hints information 1633 is temporary set-of-hints information 1623 that gives an evaluation value 1627 satisfying the predetermined condition in Step 1710 (or temporary set-of-hints information 1623 that gives a relatively high (e.g., the highest) evaluation value 1627). The matching search range information 1634 is the temporary search range information 1644 (temporary search hop count information) representing a search range in a case where set-of-hints information included in the temporary set-of-hints information 1623 having been determined as the matching set-of-hints information 1633 is collected in the knowledge graph 181 (e.g., a range that can be covered with a predetermined node hop count as counted from a certain node as the start point).

Note that information registered (recorded) in the knowledge graph system 180 by the matching information registration instruction 1630 is not limited to the matching set-of-hints information 1633 or the matching search range information 1634 described above. It is sufficient if, typically, information registered (recorded) in the knowledge graph system 180 by the matching information registration instruction 1630 is information representing a technique to collect hint information for forming optimized set-of-hints information.

### 4-4. Process of Displaying of Supplementary Document (FIGS. 18 and 19)

In the embodiment of the present disclosure, by the system 101 accepting the knowledge graph information 167 from the knowledge graph system 180, it can be expected that the prompt 168 based on the target (e.g., a facility or an infrastructure) of knowledge represented by the knowledge graph 181 is constructed or the prompt 168 is constructed after matters having been subjected to omission or the like in the document information 162 have been supplemented or corrected. Here, in the embodiment of the present disclosure, the knowledge graph information 167 may be used not only for construction of the prompt 168. Supplementary document information 1841 (supplementary document) which is a result obtained by supplementing or correcting the document information 162 with use of the knowledge graph information 167 may be presented (displayed) to a person who handles the target (e.g., a facility or an infrastructure) of knowledge represented by the knowledge graph 181, and the suitability of the contents of the supplementary document information 1841 (supplementary document) may be checked.

FIG. 18 depicts a functional configuration 1800 related to displaying of the supplementary document information 1841 (supplementary document) and checking of the suitability of the contents of the supplementary document information 1841 (supplementary document). As depicted in FIG. 18, in addition to the functional sections having already been explained, the system 101 may have a supplementary document information generating section 141, a supplementary document display control section 142, and a supplementary document suitability information accepting section 143. In addition, as depicted in FIG. 18, in addition to the information (data) having already been explained, the system 101 may handle the supplementary document information 1841 and supplementary document suitability information 1843.

FIG. 19 depicts a display screen (displaying of a supplementary document) 1900 displayed by the display/output apparatus 207 on the basis of control performed by the supplementary document display control section 142. FIG. 19 also depicts information input, by using the input apparatus 206, by a person who handles the target (e.g., a facility or an infrastructure) of knowledge represented by the knowledge graph 181.

With reference to FIG. 18 and FIG. 19, the following explains a process related to displaying of a supplementary document formed by supplementing or correcting the document information 162 on the basis of the knowledge graph information 167 and checking of the suitability of the contents of the supplementary document.

Processes to be performed until the system 101 accepts the document information 162 and the knowledge graph information 167 and constructs (a candidate of) the prompt 168 on the basis of these pieces of information may be similar to processes having already been explained (e.g., the processes in Step 801 to Step 813 in FIG. 8). It should be noted that, before the constructed prompt 168 is presented to the language model system 190, processes related to displaying of a supplementary document and checking of the suitability of the contents of the supplementary document like the one depicted below are performed.

First, the supplementary document information generating section 141 generates the supplementary document information 1841 on the basis of the document information 162 and the knowledge graph information 167. The supplementary document information 1841 is obtained by reflecting, on the document information 162, the context of the target (e.g., a facility or an infrastructure) of knowledge represented by the knowledge graph 181 or obtained by supplementing or correcting matters having been subjected to omission or the like in the document information 162. Note that the prompt constructing section 108 may also play the role of the supplementary document information generating section 141.

Next, the supplementary document display control section 142 controls the display/output apparatus 207 to perform displaying based on the supplementary document information 1841.

In the example of the display screen (the displaying of the supplementary document) depicted in FIG. 19, on a window 1901, in response to the document 161 (document information 162) input by a person who handles the target (e.g., a facility or an infrastructure) of knowledge represented by the knowledge graph 181, “In regular maintenance on Oct. 1, 2022, the component numbers 100 and 101 were replaced in the facility X.,” texts representing the supplementary document information 1841 (supplementary document), “The following is proposed as update information.,” “In regular maintenance on Oct. 1, 2022, the following was implemented:,” “(1) On the basis of TBM replacement rules, the component A (component number 100) at the portion Y of the facility X was replaced.,” and “(2) On the basis of TBM replacement rules, the component B (component number 101) at the portion Y of the facility X was replaced.,” and a chart representing the relations between solid-line frames having respective labels, “facility X,” “portion Y,” “portion A, component number 100,” “TMB 10000h (about component A),” “component B, component number 101,” and “TBM 10000h (about component B),” are displayed. Note that “TBM” is an abbreviation of “Time Based Maintenance,” and means time intervals at which maintenance (e.g., replacement of a component) is performed regardless of whether or not there is a malfunction.

A person who views texts and a chart which are the supplementary document information 1841 (supplementary document) like the one depicted in FIG. 19 determines the suitability of the contents of the supplementary document information 1841 (supplementary document). If the person determines that the contents of the supplementary document information 1841 (supplementary document) are suitable, as depicted in FIG. 19, the person inputs “The proposal is approved.” by using the input apparatus 206. The information, “The proposal is approved.,” serves as the supplementary document suitability information 1843.

In response to acceptance of the supplementary document suitability information 1843 from the input apparatus 206, the supplementary document suitability information accepting section 143 transmits the supplementary document suitability information 1843 to the prompt constructing section 108.

After checking that the supplementary document suitability information 1843 has contents confirming the suitability of the supplementary document information 1841, the prompt constructing section 108 transmits the constructed prompt 168 to the prompt presenting section 109. Processes to be performed after the prompt 168 is transmitted to the prompt presenting section 109 may be similar to those having already been explained (e.g., the processes performed in Step 814 and the subsequent steps in FIG. 8).

Note that, in a case where the supplementary document suitability information 1843 has contents negating the suitability of the supplementary document information 1841, the prompt constructing section 108 may redo the construction of the prompt 168, and the supplementary document information generating section 141 may redo the generation of the supplementary document information 1841.

As described above, in a case where displaying of the supplementary document information 1841 (supplementary document) and checking of the suitability of the contents of the supplementary document information 1841 (supplementary document) are performed, for example, a person who handles the target (e.g., a facility or an infrastructure) of knowledge represented by the knowledge graph 181 can check whether contents of updating of the knowledge graph 181 that the system 101 is about to perform are suitable, at a stage before examination of the suitability of the update query 171 as in Step 817 in FIG. 8.

### 4-5. Process of Displaying of Uniqueness Inquiry (FIGS. 20 and 21)

In the embodiment of the present disclosure, there can be cases where the extent of omission or the like in the document information 162 accepted by the system 101 is extremely significant. Accordingly, when the system 101 attempts to supplement or correct matters having been subjected to omission or the like in the document information 162, on the basis of the knowledge graph information 167, there can be cases where the intention of a person who has input the document information 162 cannot be identified uniquely.

In view of this, in the embodiment of the present disclosure, such a process as displaying of a uniqueness inquiry for uniquely identifying the intention of a person who has input the document information 162, for example, may be performed.

FIG. 20 depicts a functional configuration 2000 related to displaying of choice information 2044 for a uniqueness inquiry and checking of the intention of a person who has input the document information 162, for example. As depicted in FIG. 20, in addition to the functional sections having already been explained, the system 101 may have a uniqueness deciding section 144, a choice display control section 145, and a selection information accepting section 146. In addition, as depicted in FIG. 20, in addition to the information (data) having already been explained, the system 101 may handle the choice information 2044 and selection information 2046.

FIG. 21 depicts a display screen (displaying of a uniqueness inquiry) 2100 displayed by the display/output apparatus 207 on the basis of control performed by the choice display control section 145. FIG. 21 also depicts information input, by using the input apparatus 206, by a person (a person who has input the document information 162, for example) who handles the target (e.g., a facility or an infrastructure) of knowledge represented by the knowledge graph 181.

With reference to FIG. 20 and FIG. 21, the following explains processes related to displaying of a uniqueness inquiry and checking of the intention of a person who has input the document information 162, for example.

Processes to be performed until the system 101 accepts the document information 162 and the knowledge graph information 167 and constructs (a candidate of) the prompt 168 on the basis of these pieces of information may be similar to processes having already been explained (e.g., the processes in Step 801 to Step 813 in FIG. 8). It should be noted that, before the constructed prompt 168 is presented to the language model system 190, (in a situation where the uniqueness as intended by the document information 162 is doubted) processes related to displaying of a uniqueness inquiry and checking of the intention of a person who has input the document information 162, for example, like the one depicted below are performed.

First, the uniqueness deciding section 144 decides whether the updated contents, based on the document information 162, of the knowledge graph 181 are identified uniquely, on the basis of the document information 162 and the knowledge graph information 167. In a case where it is decided that the updated contents, based on the document information 162, of the knowledge graph 181 cannot be identified uniquely, the uniqueness deciding section 144 generates the choice information 2044 representing choices of the updated contents of the knowledge graph 181, on the basis of the document information 162. Note that the uniqueness deciding section 144 may use the language model 191 in order to perform the decision. In addition, the prompt constructing section 108 may also play the role of the uniqueness deciding section 144.

Next, the choice display control section 145 controls the display/output apparatus 207 to perform displaying based on the choice information 2044.

In the example of the display screen (displaying of a uniqueness inquiry) depicted in FIG. 21, in response to the document 161 (document information 162) input by a person who handles the target (e.g., a facility or an infrastructure) of knowledge represented by the knowledge graph 181, “In regular maintenance on Oct. 1, 2022, the component number 100 was replaced in the facility X.,” a window 2101 displays texts representing the choice information 2044, “Updating cannot be identified uniquely.,” “(1) On the basis of TBM replacement rules, the component A (component number 100) at the portion Y of the facility X was replaced.,” and “(2) Due to a sudden malfunction, the component A (component number 100) at the portion Z of the facility X was replaced.,” and a chart representing the relations between solid-line frames having respective labels, “facility X,” “portion Y,” “component A (of portion Y), component number 100,” “TBM 10000h (about component A of portion Y),” “hours of operational use (about component A of portion Y): 9000h,” “portion Z,” “component A (of portion Z), component number 100,” “TBM 10000h (about component A of portion Z),” and “hours of operational use (about component A of portion Z): 1000h.” The example depicted in FIG. 21 depicts that it cannot be identified uniquely whether the component A represented by “the component number 100 was replaced” in the document information 162 is the component A included in the portion Y or the component A included in the portion Z, even by taking into consideration the knowledge graph information 167.

A person who views the texts and the chart representing the choice information 2044 in FIG. 21 determines which of (1) and (2) displayed as choices is intended by the document information 162. The person inputs the selection information 2046 representing a determined choice, by using the input apparatus 206. In the example depicted in FIG. 21, the person inputs “The proposal (1) is approved.” by using the input apparatus 206. That is, information representing that the choice (1) is chosen from the choices (1) and (2) becomes the selection information 2046.

In response to acceptance of the selection information 2046 from the input apparatus 206, the selection information accepting section 146 transmits the selection information 2046 to the prompt constructing section 108.

The prompt constructing section 108 constructs the prompt 168 such that the prompt 168 reflects the selection information 2046. The prompt constructing section 108 transmits the constructed prompt 168 to the prompt presenting section 109. Processes to be performed after the prompt 168 is transmitted to the prompt presenting section 109 may be similar to those having already been explained (e.g., the processes performed in Step 814 and the subsequent steps in FIG. 8).

As described above, also in a case where, when the system 101 attempts to supplement or correct matters having been subjected to omission or the like in the document information 162 on the basis of the knowledge graph information 167, the system 101 cannot uniquely identify the intention of a person who has input the document information 162, the system 101 can appropriately perform updating of the knowledge graph 181 after checking the intention of the person who has input the document information 162, for example.

### 4-6. Process of Editing of Knowledge Graph Information (Hint Information) (FIG. 22 and FIG. 23)

In the embodiment of the present disclosure, the knowledge graph 181 has node information about each of nodes and edge information about each of edges as knowledge graph information. The node information and the edge information (other than set-of-hints information) may be called hint information, as has already been explained. Here, the embodiment of the present disclosure may have a user interface that enables manual editing of knowledge graph information (hint information) about nodes or edges of the knowledge graph 181.

FIG. 22 depicts a functional configuration 2200 for realizing a user interface that enables manual editing of knowledge graph information (hint information). As depicted in FIG. 22, in the embodiment of the present disclosure, in addition to the functional sections having already been explained, the system 101 may have a knowledge graph information editing screen display control section 147, a knowledge graph editing information accepting section 148, and a knowledge graph information editing instructing section 149. In addition, as depicted in FIG. 22, in the embodiment of the present disclosure, in addition to the information (data) having already been explained, the system 101 may handle knowledge graph editing information 2248 and knowledge graph information editing instruction 2249.

FIG. 23 depicts a display screen (displaying of editing of knowledge graph information (hint information)) 2300 as a user interface that enables manual editing of the knowledge graph (hint information).

With reference to FIG. 22 and FIG. 23, the following explains a process related to realization of a user interface that enables manual editing of the knowledge graph (hint information).

First, a person who handles the system 101 or the knowledge graph system 180 may input information representing the intention to edit the knowledge graph information (hint information), via the input apparatus 206. In FIG. 23, as an example in which information representing the intention to edit the knowledge graph information (hint information) is input, input contents, “Add hint information of the facility X.,” is displayed on a window 2301. The input information representing the intention to edit the knowledge graph information (hint information) is accepted by the knowledge graph editing information accepting section 148.

The knowledge graph editing information accepting section 148 requests the knowledge graph information editing screen display control section 147 to realize a knowledge graph information (hint information) editing screen suited for inputting information representing the intention to edit the knowledge graph information (hint information). In the example described above, the knowledge graph editing information accepting section 148 requests the knowledge graph information editing screen display control section 147 to realize a knowledge graph information editing screen that enables editing of the knowledge graph information (hint information) related to the facility X.

The knowledge graph information editing screen display control section 147 controls the display/output apparatus 207 to realize a knowledge graph information (hint information) editing screen. In order to realize the knowledge graph information (hint information) editing screen that enables editing of the knowledge graph information (hint information) about the facility X, on the window 2301 in FIG. 23, texts, “The diagram below depicts asset nodes included in the facility X and edges between assets.” and “Click an asset node or an edge to edit its hint information.,” are displayed, and a chart related to the facility X representing the relations between solid-line frames having respective labels, “facility X,” “portion Y,” “portion A, component number 100,” and “component B, component number 101,” are displayed. Note that, in order to realize an editing screen like the one depicted in FIG. 23, the knowledge graph information editing screen display control section 147 may accept, from the knowledge graph system 180, node information and edge information in the knowledge graph corresponding to the facility X.

A person who edits knowledge graph information (hint information) selects any one of nodes (e.g., asset nodes) or edges (e.g., edge connecting asset nodes to each other) whose knowledge graph information (hint information) is desired to be edited, from the chart related to the facility X displayed on the window 2301. For example, the person who edits the knowledge graph information (hint information) clicks any one of nodes or edges in the chart related to the facility X by using the input apparatus 206 (e.g., a mouse). The selection input information about the node or the edge input via the input apparatus is accepted by the knowledge graph editing information accepting section 148.

The knowledge graph editing information accepting section 148 requests the knowledge graph information editing screen display control section 147 to realize a knowledge graph information (hint information) editing screen related to the node or the edge represented by the selection input information. In the example depicted in FIG. 23, the knowledge graph editing information accepting section 148 requests the knowledge graph information editing screen display control section 147 to realize a pop-up window 2302 which is a knowledge graph information (hint information) editing screen related to the clicked “portion A, component number 100.”

The knowledge graph information editing screen display control section 147 controls the display/output apparatus 207 to realize the pop-up window 2302 which is a knowledge graph information (hint information) editing screen. In FIG. 23, the pop-up window 2302 which is a knowledge graph information (hint information) editing screen related to “portion A, component number 100” is displayed.

The person who edits knowledge graph information (hint information) performs editing of the hint information in the pop-up window 2302. In FIG. 23, the person can execute editing of knowledge graph information (hint information) (here, asset node information other than set-of-hints information) related to “portion A, component number 100” on the pop-up window 2302. Note that, when the pop-up window 2302 pops up, the knowledge graph information (hint information) before being edited may be displayed on the pop-up window 2302. That is, editing of the knowledge graph information (hint information) with use of the pop-up window 2302 can include not only addition of knowledge graph information (hint information) but also correction of knowledge graph information (hint information) or deletion of hint information. In a case where editing of the knowledge graph information (hint information) performed using the pop-up window 2302 is confirmed, an icon “Execute” is clicked. In a case where editing of knowledge graph information (hint information) performed using the pop-up window 2302 is discarded (editing is not confirmed), an icon “Cancel” is clicked. The confirmed knowledge graph information (hint information) after being edited is treated as the knowledge graph editing information 2248.

The knowledge graph editing information 2248 is accepted by the knowledge graph editing information accepting section 148. The knowledge graph editing information accepting section 148 transmits the knowledge graph editing information 2248 to the knowledge graph information editing instructing section 149.

The knowledge graph information editing instructing section 149 presents the knowledge graph information editing instruction 2249 to the knowledge graph system 180. The knowledge graph information editing instruction 2249 is for making a request to cause the knowledge graph 181 to reflect editing (addition/correction/deletion) of knowledge graph information (hint information) included in the knowledge graph editing information 2248. The knowledge graph system 180 to which the knowledge graph information editing instruction 2249 is presented causes the knowledge graph 181 to reflect editing (addition/correction/deletion) of knowledge graph information (hint information) included in the knowledge graph editing information 2248.

Note that, whereas FIG. 23 depicts an example in which knowledge graph information (hint information) about an asset node is edited, the target of editing of knowledge graph information (hint information) may be a symptom node/malfunction mode node or may be an edge. In addition, the target of editing of knowledge graph information (hint information) is not limited to a node or an edge included in an instance group, and may be a schema node or an edge included in a schema.

In addition, whereas the explanation described above depicts an example in which node information associated with a node or edge information associated with an edge is edited, set-of-hints information that can be associated with a plurality of nodes or a plurality of edges may also be able to be edited similarly. For example, by using the technique of few short learning, the system 101 may enable editing in which, regarding an asset node on a relatively superordinate layer (e.g., an asset node representing a water supply mechanism), information representing statements, “The following is examples.,” “In a case of replacement of an asset, an installation date of the asset is updated.,” and “In a case of addition of an asset, any one of existing assets and the asset to be added are connected to each other by an edge.,” is added as set-of-hints information.

As described above, various types of knowledge graph information (e.g., hint information) that the knowledge graph 181 has can be edited using contents as intended by a person who handles the system 101 or the knowledge graph system 180.

### 5. Others (Modification Examples)

The present disclosure is not limited to the embodiment described above, and includes various modification examples. Some of configurations or processes according to the embodiment may be replaced with configurations or processes according to another conceivable embodiment. Configurations or processes according to another conceivable embodiment may be added to configurations or processes according to the embodiment.

For example, in the present disclosure, there can be modification examples of the embodiment like the ones below.

### (A) Modification Example of Construction of Asset Identification Request Prompt (FIGS. 24 and 25)

In the embodiment described above, the asset identification request prompt constructing section 103 constructs the asset identification request prompt 163 on the basis of the document information 162. However, in a case where training by machine learning specialized for domain knowledge about the target (e.g., a facility or an infrastructure) of knowledge represented by the knowledge graph 181 has not been performed for the language model 191, there can be cases where the language model 191 cannot appropriately extract, from the document information 162, the names or the like of elements (e.g., assets) included in the target (e.g., a facility or an infrastructure).

In view of this, in a modification example, by including, in the asset identification request prompt 163, information or knowledge included in the knowledge graph 181, the language model 191 may be made capable of appropriately extracting the names or the like of elements (e.g., assets) from the document information 162.

FIG. 24 depicts a functional configuration related to construction of the asset identification request prompt 163 in the modification example. In the modification example, in addition to the functional sections having already been explained, the system 101 may have an asset name list information requesting section 114 and an asset name list information accepting section 115. In the modification example, in addition to the information (data) having already been explained, the system 101 may handle asset name list information request 2414 and the asset name list information 2415.

FIG. 25 depicts the asset identification request prompt template 2500 that can be used in the modification example. FIG. 25 has already been explained. The following adds some explanations.

The asset identification request prompt template 2500 may include, at the beginning, a text representing an outline of a request, “Please identify assets from the following statement, and output an identified-asset list which is a list listing the identified assets.,” a text representing a general explanation about assets, “Assets are nouns. Assets are the names of equipment.,” and a text specifying a response format of a response by the language model 191, “Please output the identified-asset list in the document format Y.” In addition, the asset identification request prompt template 2500 may include a text for prompting the language model 191 to use the asset name list information 2415 as a hint, “Asset candidates include the following ones. It should be noted that those other than the following candidates can be assets.,” and it may be possible to insert the asset name list information 2415 to the portion {hint}. Further, the asset identification request prompt template 2500 may include a text, “#statement,;” and it may be possible to insert the document information 162 to the portion {text}. The asset identification request prompt template 2500 may include a text, “#Identified-asset list in the document format Y:.” Later on, the identified-asset response information 164 (identified-asset list), which is a response from the language model 191, may be inserted immediately after “#Identified-asset list in the document format Y:.” Note that an example of the document format Y described above is a CSV format.

With reference to FIG. 24 and FIG. 25, a process performed until construction of an asset identification request prompt in the modification example is explained.

First, the asset name list information requesting section 114 presents the asset name list information request 2414 to the knowledge graph system 180. The asset name list information request 2414 is for requesting the asset name list information 2415, which is information representing a list of the names of elements (e.g., assets) included in the target (e.g., a facility or an infrastructure) of knowledge represented by the knowledge graph 181. The range of elements (e.g., assets) whose names are collected may be the entire knowledge graph 181 or may be a portion of the knowledge graph 181 as specified on the basis of the contents of the document information 162. In addition, elements which are the targets of collection of names may be elements other than assets.

The knowledge graph system 180 may collect the names of elements (e.g., assets) from the entire knowledge graph 181 or a portion of the knowledge graph 181 in response to presentation of the asset name list information request 2414. Alternatively, the knowledge graph system 180 may read out list information about the names of elements (e.g., assets) that has been prepared in advance. The knowledge graph system 180 presents, to the system 101 and as the asset name list information 2415, information representing a list of the names of elements (e.g., assets) having been collected or read out.

The asset name list information accepting section 115 accepts the asset name list information 2415 from the knowledge graph system 180. The asset name list information accepting section 115 transmits the asset name list information 2415 to the asset identification request prompt constructing section 103.

The asset identification request prompt constructing section 103 constructs the asset identification request prompt 163 on the basis of the document information 162 and the asset name list information 2415. For example, in a case where the asset identification request prompt template 2500 depicted in FIG. 25 is used, the asset identification request prompt constructing section 103 may construct the asset identification request prompt 163 by inserting the asset name list information 2415 to the portion {hint} and inserting the document information 162 to the portion {text} in the asset identification request prompt template 2500.

Processes after the asset identification request prompt 163 is constructed may be similar to those having already been explained (e.g., the processes performed in Step 803 and the subsequent steps in FIG. 8).

A modification example like this can enhance the probability that the language model 191 generates (outputs) the identified-asset response information 164 (identified-asset list) with appropriate contents.

### (B) Modification Example of Knowledge Graph Information Request and Knowledge Graph Information Acceptance (FIG. 26)

In the embodiment described above, as represented by Step 807 and Step 808 in FIG. 8, communication between the system 101 and the knowledge graph system 180 is performed in such a manner that, once the system 101 presents the knowledge graph information request 166 to the knowledge graph system 180, accordingly, the knowledge graph system 180 collectively presents, to the system 101, the knowledge graph information 167 (e.g., set-of-hints information or hint information) related to the identified assets 182 and the related assets 183.

In a modification example, communication between the system 101 and the knowledge graph system 180 may be performed dialogically as compared to that depicted in FIG. 8.

FIG. 26 depicts a flowchart 2600 of a process in the modification example. In the modification example, the portions of Step 807 and Step 808 in the flowchart depicted in FIG. 8 are replaced with their counterparts depicted in FIG. 26. In the modification example, Step 2605 in FIG. 26 may be executed after Step 804 in FIG. 8.

In Step 2605 in FIG. 26, the knowledge graph information requesting section 106 may present a preliminary knowledge graph information request to the knowledge graph system 180. The preliminary knowledge graph information request is for requesting (inquiring), from the knowledge graph system 180, information about an unknown asset identifier of an asset (identified asset) among assets whose names are represented by the document information 162. For example, in the example of the document information 162A (maintenance document A) in FIG. 11, the asset identifier P001 is clearly represented for “water supply mechanism,” but asset identifiers are not represented for “second pump” and “impeller.” Information about the asset identifier of “second pump” included in “water supply mechanism P001” and information about the asset identifier of “impeller” included in “second pump” can be asked for by the preliminary knowledge graph information request.

The knowledge graph system 180 collects preliminary knowledge graph information including information about inquired asset identifiers in response to the preliminary knowledge graph information request. The knowledge graph system 180 presents the preliminary knowledge graph information to the system 101.

In Step 2606 in FIG. 26, the knowledge graph information accepting section 107 accepts the preliminary knowledge graph information including the information about the asset identifiers from the knowledge graph system 180. By Step 2605 and Step 2606, the system 101 can know the asset identifiers of the assets (identified assets) whose names are represented by the document information 162. After Step 2606, the control proceeds to Step 2607.

By a processing step group represented by the loop of Step 2607, Step 2608, and Step 2609, the system 101 and the knowledge graph system 180 may dialogically and sequentially transmit and receive knowledge graph information (e.g., node information or edge information) about each of the identified assets 182 and the related assets 183 related to the document information 162.

Specifically, in Step 2607 in FIG. 26, the knowledge graph information requesting section 106 presents the knowledge graph information request to the knowledge graph system 180. In the modification example, the knowledge graph information request presented in Step 2607 includes any one piece of identified-asset information or any one piece of related-asset information which is known by the system 101 at the moment. For example, in a case where, when Step 2607 is executed for the first time, the system 101 knows the identified assets 182 related to the document information 162 but does not know the related assets 183, a knowledge graph information request made at the time when Step 2607 is executed for the first time may include identified-asset information about any one of the known identified assets 182.

The knowledge graph system 180 collects knowledge graph information about identified-asset information or related-asset information included in the presented knowledge graph information request. Here, the collected knowledge graph information may include related-asset information that identifies the related assets 183 which are unknown to the system 101 at the moment. The knowledge graph system 180 presents the collected knowledge graph information to the system 101.

In Step 2608 in FIG. 26, the knowledge graph information accepting section 107 accepts the knowledge graph information from the knowledge graph system 180. The knowledge graph information accepted here is knowledge graph information about identified-asset information or related-asset information having been included in the knowledge graph information request in Step 2607, which is the previous step. As has already been pointed out, the knowledge graph information may include related-asset information that identifies the related assets 183 that have been unknown to the system 101.

In Step 2609 in FIG. 26, the knowledge graph information requesting section 106 determines whether the information (identified-asset information) about the assets (identified assets) whose names have been included in the document information 162 and the related-asset information which is information about the related assets 183 included in the knowledge graph information accepted in Step 2608 include information that is included in the knowledge graph information request in Step 2607 but still has not been presented to the knowledge graph system 180. In a case where a determination result of Step 2609 is YES (the identified-asset information or the related-asset information includes information that has not been presented in Step 2607), the control returns to Step 2607. If the determination result of Step 2609 is NO, the control proceeds to Step 810.

The modification example described above can reduce the extent of collective collection of knowledge graph information in the knowledge graph system 180 as compared to a case where the processing steps in the flowchart depicted in FIG. 8 are realized. Accordingly, the modification example described above can simplify functions of the knowledge graph system 180 to control the knowledge graph 181.

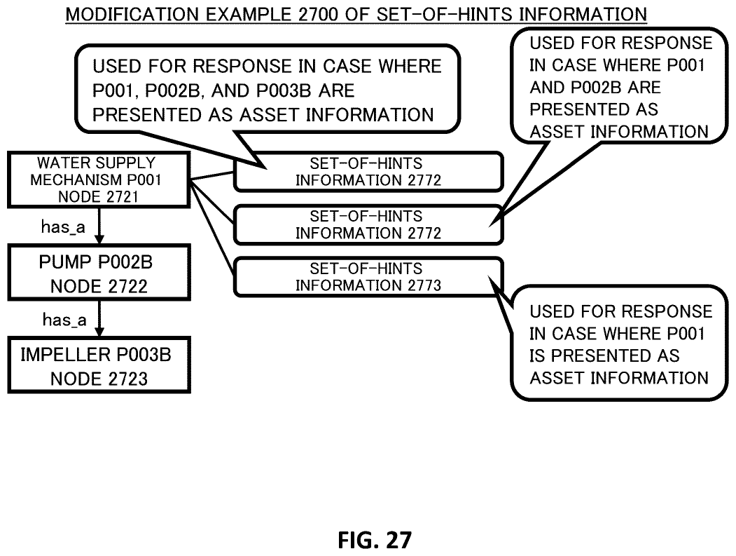

### (C) Modification Example of Set-of-Hints Information (FIG. 27)

It is assumed in the embodiment described above that one piece of set-of-hints information is associated with an asset node on a relatively superordinate layer (e.g., an asset node representing the water supply mechanism).

In a modification example, there may be a plurality of pieces of set-of-hints information associated with one asset node.

FIG. 27 depicts a mode 2700 of set-of-hints information in the modification example. In FIG. 27, an asset node 2721 representing “water supply mechanism P001,” which is an asset node on a relatively superordinate layer, is associated with set-of-hints information 2771, set-of-hints information 2772, and set-of-hints information 2773.

For example, the knowledge graph system 180 may select set-of-hints information to be presented to the system 101, depending on combination of asset nodes presented by the system 101 as a combination of identified-asset information or related-asset information. For example, in a case where “water supply mechanism P001,” “pump P002B,” and “impeller P003B” are presented simultaneously by the system 101, the knowledge graph system 180 may present the set-of-hints information 2771 to the system 101. In a case where “water supply mechanism P001” and “pump P002B” are presented simultaneously by the system 101, the knowledge graph system 180 may present the set-of-hints information 2772 to the system 101. In a case where only “water supply mechanism P001” is presented by the system 101, the knowledge graph system 180 may present the set-of-hints information 2773 to the system 101.

In the modification example described above, the knowledge graph system 180 can present more appropriate set-of-hints information to the system 101, depending on the contents of the knowledge graph information request 166 that the system 101 presents to the knowledge graph system 180.

### (D) Modification Example Related to Displaying of Supplementary Document (FIG. 28)

As depicted in FIG. 18, in the embodiment described above, the supplementary document suitability information 1843 is used for checking the suitability of the prompt 168 constructed by the prompt constructing section 108.

In a modification example, the supplementary document suitability information 1843 may be used for checking the suitability of the update query 171 constructed by the update query constructing section 111.

FIG. 28 depicts a functional configuration in the modification example. When FIG. 18 and FIG. 28 are compared with each other, they are different from each other in terms of information to be used by the supplementary document information generating section 141 in FIG. 18 and supplementary document information generating section 2841 in FIG. 28 when generating the supplementary document information 1841. In addition, while the supplementary document suitability information 1843 is input to the prompt constructing section 108 in FIG. 18, the supplementary document suitability information 1843 is input to the update query constructing section 111 in FIG. 28.

The following explains (differences from FIG. 18 of) processes in FIG. 28.

As depicted in FIG. 28, in the modification example, the supplementary document information 1841 (supplementary document) is generated after the response information 170, which is an output from the language model 191, is accepted by the system 101 (response information accepting section 110). The supplementary document information generating section 2841 generates the supplementary document information 1841 (supplementary document) on the basis of the response information 170 (or on the basis of the response information 170 and the document information 162).

The supplementary document suitability information 1843 that a person who handles the system 101 or the knowledge graph system 180 has input via the input apparatus 206 is input to the update query constructing section 111 (or an examining section which is not depicted). In a case where the supplementary document suitability information 1843 represents confirmation of the suitability of the supplementary document information 1841 (supplementary document), the update query constructing section 111 may construct the update query 171. In a case where the supplementary document suitability information 1843 represents negation of the suitability of the supplementary document information 1841 (supplementary document), the update query constructing section 111 may stop construction of the update query 171. In this case, for example, the system 101 may restart from the process performed by the prompt constructing section 108. Note that, in a case where the supplementary document suitability information 1843 is input to the examining section (which is not depicted), an examination result of an update query at the examining section may reflect the supplementary document suitability information 1843.

In the modification example described above, results of determination made by a person who handles the system 101 or the knowledge graph system 180 about both the suitability of supplementation or correction of portions having been subjected to omission or the like in the document information 162 based on the knowledge graph information 167 and the suitability of the response information 170 generated (output) by the language model 191 can be reflected in a series of processes performed in the system 101.

### (E) Modification Example Related to Displaying of Uniqueness Inquiry (FIG. 29)

As depicted in FIG. 20, in the embodiment described above, the selection information 2046 is used by the prompt constructing section 108 to construct the prompt 168.

In a modification example, in a case where the updated contents, based on the document information 162, of the knowledge graph 181 cannot be identified uniquely even if the knowledge graph information 167 is used, the system 101 may construct a different prompt for each possible choice of the updated contents of the knowledge graph 181, and obtain different response information 170 from the language model 191. Then, the system 101 may select any one piece of response information 170 on the basis of the selection information 2046.

The following explains (differences from FIG. 20 of) processes in FIG. 29.

In the modification example, in a case where it is decided that the updated contents, based on the document information 162, of the knowledge graph 181 cannot be identified uniquely even if the knowledge graph information 167 is used, the prompt constructing section 108 constructs a different prompt for each possible choice of the updated contents of the knowledge graph 181. Note that, for the decision, the prompt constructing section 108 may use the language model 191.

In a case where different prompts are constructed, different response information 170 for each prompt is provided from the language model system 190 to the system 101 (response information accepting section 110).

A uniqueness deciding section 2944 decides whether or not there are a plurality of pieces of response information 170 for the document information 162. In a case where there is one piece of response information 170 for the one piece of document information 162, uniqueness of the document information 162 is ensured, and accordingly, subsequent processes may be similar to the processes explained in FIG. 8. In a case where there are a plurality of pieces of response information 170 for the one piece of document information 162, the uniqueness deciding section 2944 generates choice information 2044 representing the contents of each of the pieces of response information 170 as a choice.

The selection information 2046 that a person who handles the system 101 or the knowledge graph system 180 has input via the input apparatus 206 is input to the update query constructing section 111. The update query constructing section 111 selects response information 170 corresponding to a choice represented by the selection information 2046, and constructs the update query 171 by using the selected response information 170.

In the modification example described above, in a case where uniqueness of the document information 162 is not sufficient, a person who handles the system 101 or the knowledge graph system 180 can select the updated contents of the knowledge graph 181 by using the response information 170 which is direct information for constructing the update query 171.

(F) Modification Example in which Set-of-Hints Information is not Used

In the embodiment described above, there is set-of-hints information as knowledge graph information in the knowledge graph 181, or set-of-hints information can be registered (recorded) as knowledge graph information in the knowledge graph 181 additionally.

In a modification example, the knowledge graph 181 includes, as knowledge graph information, node information (other than set-of-hints information) about nodes included in the knowledge graph 181 and edge information about edges included in the knowledge graph 181, but the knowledge graph 181 may include information not in a format of set-of-hints information (or information may be registered (recorded) in the knowledge graph 181 not in a format of set-of-hints information).

The modification example described above attains an advantage that, although there is a possibility that the processing load of the system 101 increases since information in a set-of-hints information mode is constructed in the system 101 every time construction of a prompt is performed, management of information in the knowledge graph 181 is simplified since there is not set-of-hints information in the knowledge graph 181.

(G) Modification Example in which Only Set-of-Hints Information is Used

In the embodiment described above, the knowledge graph 181 can include, as knowledge graph information, node information (other than set-of-hints information) about nodes included in the knowledge graph 181 and edge information about edges included in the knowledge graph 181.

In a modification example, for example, the knowledge graph 181 may include, as knowledge graph information, set-of-hints information associated with asset nodes on a relatively superordinate layer, but the knowledge graph 181 may not include node information (other than set-of-hints information) about nodes included in the knowledge graph 181 and edge information about edges included in the knowledge graph 181.

The modification example described above attains an advantage that, while there is a possibility that time and effort is needed to register (record), from the beginning in an aggregated manner, knowledge graph information about a plurality of nodes and a plurality of edges as, for example, set-of-hints information associated with asset nodes on a relatively superordinate layer, the knowledge graph information can be kept undispersed and aggregated in the knowledge graph 181.

(H) Modification Example in which Language Model is Caused to Generate Update Query

In the embodiment described above, the update query constructing section 111 in the system 101 constructs the update query 171 on the basis of the response information 170 generated (output) by the language model 191.

In a modification example, the contents of a request to the language model 191 based on the prompt 168 may be treated as a request for generation of the update query 171. In the modification example, the language model 191 generates (outputs) the update query 171, and the system 101 accepts the update query 171. The system 101 presents the accepted update query 171 to the knowledge graph system 180. In the modification example, the system 101 may not have the update query constructing section 111.

In the modification example described above, while there is a possibility that the degree of freedom of construction of the update query 171 is lowered, it is possible to realize simplification of the functional configuration of the system 101.

The technical matters depicted for the embodiment of the present disclosure and each of the modification examples of the embodiment depicted in the description above can be combined as appropriate unless such combinations do not cause technical contradictions.

What is claimed is:

1. A system comprising:
a document information accepting section that accepts document information which is information included in a document that triggers updating of a knowledge graph;
a knowledge graph information accepting section that accepts knowledge graph information which is information included in the knowledge graph from a knowledge graph system that manages the knowledge graph;
a prompt constructing section that constructs, on a basis of the document information and the knowledge graph information, a prompt for requesting presentation of information to be used for construction of an update query for updating the knowledge graph;
a prompt presenting section that presents the prompt to a language model system that manages a language model;
a response information accepting section that accepts response information representing a response from the language model system to the prompt;
an update query constructing section that constructs the update query on a basis of the response information; and
an update query presenting section that presents the update query to the knowledge graph system.

2. The system according to claim 1, wherein
the knowledge graph represents knowledge about one or more assets,
the system further has a knowledge graph information requesting section that presents a knowledge graph information request to the knowledge graph system, the knowledge graph information request including identified-asset information that identifies, as identified assets, one or more assets described in the document,
the knowledge graph information includes hint information,
the hint information is about one or more identified assets or one or more related assets related to the one or more identified assets, and
the prompt constructing section constructs the prompt on a basis of the document information and the hint information.

3. The system according to claim 2, wherein
the system further has a set-of-hints information registration instructing section that presents, to the knowledge graph system, a set-of-hints information registration instruction for updating the knowledge graph such that a set of the hint information including one or more pieces of the hint information is made set-of-hints information about a certain asset.

4. The system according to claim 2, wherein
the system further has
an asset identification request prompt constructing section that constructs an asset identification request prompt for requesting the language model to identify one or more identified assets described in the document, on a basis of the document information,
an asset identification request prompt presenting section that presents the asset identification request prompt to the language model system, and
an identified-asset response information accepting section that accepts identified-asset response information representing a response from the language model system to the asset identification request prompt, and
the knowledge graph information requesting section specifies the identified-asset information to be presented to the knowledge graph system, on a basis of the identified-asset response information.

5. The system according to claim 4, wherein
the system further has an asset name list information accepting section that accepts, from the knowledge graph system, asset name list information representing a list of asset names in the knowledge graph, and
the asset identification request prompt constructing section constructs the asset identification request prompt on a basis of the document information and the asset name list information.

6. The system according to claim 1, wherein
the knowledge graph represents knowledge about one or more assets,
the system further has a knowledge graph information requesting section that presents a knowledge graph information request to the knowledge graph system, the knowledge graph information request including identified-asset information that identifies, as identified assets, one or more assets described in the document,
the knowledge graph information includes hint information or set-of-hints information,
the hint information is about one or more identified assets or one or more related assets related to the one or more identified assets,
the set-of-hints information is about a certain asset of the identified assets or the related assets,
in a case where the set-of-hints information is included in the accepted knowledge graph information, the prompt constructing section constructs the prompt on a basis of the document information and the set-of-hints information, and,
in a case where the set-of-hints information is not included in the accepted knowledge graph information, the prompt constructing section constructs the prompt on a basis of the document information and the hint information.

7. The system according to claim 1, wherein
the knowledge graph represents knowledge about one or more assets,
the system further has a knowledge graph information requesting section that presents a knowledge graph information request to the knowledge graph system, the knowledge graph information request including identified-asset information that identifies, as identified assets, one or more assets described in the document,
the knowledge graph information includes set-of-hints information,
the set-of-hints information is about a certain asset of one or more identified assets or one or more related assets related to the one or more identified assets, and
the prompt constructing section constructs the prompt on a basis of the document information and the set-of-hints information.

8. The system according to claim 1, wherein
the knowledge graph represents knowledge about one or more assets,
the system further has
a knowledge graph update history accepting section that accepts, from the knowledge graph system, past document information which is information included in a document that has triggered updating of the knowledge graph performed in a past time and past difference information representing modified contents of the knowledge graph in the updating,
a hint information group accepting section that accepts, from the knowledge graph system, a hint information group including hint information about one or more assets, and
a temporary set-of-hints forming section that selects one or more pieces of the hint information from the hint information group and forms temporary set-of-hints information including the selected hint information,
the prompt constructing section constructs a temporary prompt on a basis of the past document information and the temporary set-of-hints information,
the prompt presenting section presents the temporary prompt to the language model system,
the response information accepting section accepts temporary response information representing a response from the language model system to the temporary prompt, and
the system further has
a temporary difference information identifying section that identifies temporary difference information representing modified contents of the knowledge graph in a case where a temporary update query is constructed on a basis of the temporary response information and the temporary update query is applied to the knowledge graph,
a degree-of-similarity calculating section that calculates a degree of similarity between the modified contents of the knowledge graph represented by the past difference information and the modified contents of the knowledge graph represented by the temporary difference information,
a matching set-of-hints information identifying section that acquires the degree of similarity to each piece of the temporary set-of-hints information and identifies matching set-of-hints information which is matching temporary set-of-hints information on a basis of the degrees of similarity, by controlling the temporary set-of-hints forming section, the prompt constructing section, the prompt presenting section, the response information accepting section, the temporary difference information identifying section, and the degree-of-similarity calculating section, and
a matching information registration instructing section that presents, to the knowledge graph system, a matching information registration instruction for updating the knowledge graph such that the matching set-of-hints information or matching search range information representing a range that is searched in the knowledge graph to collect the hint information included in the matching set-of-hints information is made set-of-hints information or search range information about a certain asset.

9. The system according to claim 8, wherein
the matching set-of-hints information identifying section identifies the matching set-of-hints information on a basis of the degree of similarity and additionally on a basis of the number of pieces of the hint information included in the temporary set-of-hints information or temporary search range information representing a range that is searched in the knowledge graph to collect the hint information included in the temporary set-of-hints information.

10. The system according to claim 2, wherein
the knowledge graph is for managing the assets, symptoms that the assets can exhibit, and malfunction modes that the assets can be in, managing relations between the assets, and managing relations between the assets, the symptoms, and the malfunction modes,
the hint information is information representing attributes that the assets have, relations between the assets, relations between the assets and the symptoms, or relations between the symptoms and the malfunction modes, and
the document that triggers updating of the knowledge graph is a maintenance document.

11. The system according to claim 1, wherein
the system further has
a supplementary document information generating section that generates supplementary document information representing a supplementary document supplemented with contents of the document, on a basis of the document information and the knowledge graph information,
a supplementary document display control section that performs control such that the supplementary document is displayed, on a basis of the supplementary document information, and
a supplementary document suitability information accepting section that accepts supplementary document suitability information which is input information representing whether or not the supplementary document is suitable.

12. The system according to claim 1, wherein
the system further has
a uniqueness deciding section that decides whether or not updated contents of the knowledge graph represented by the document are identified uniquely, on a basis of the document information and the knowledge graph information,
a choice display control section that performs control such that choices that can be the updated contents of the knowledge graph represented by the document are displayed, in a case where the updated contents of the knowledge graph represented by the document are not identified uniquely, and
a selection information accepting section that accepts selection information representing which of the choices is selected.

13. The system according to claim 1, wherein
the system further has
a knowledge graph editing information accepting section that accepts knowledge graph editing information based on an input for editing knowledge graph information, and
a knowledge graph information editing instructing section that presents, to the knowledge graph system, a knowledge graph information editing instruction for causing the knowledge graph to reflect edited contents of the knowledge graph information represented by the knowledge graph editing information.

14. A method executed by a system, the method comprising:
a document information acceptance step of accepting document information which is information included in a document that triggers updating of a knowledge graph;
a knowledge graph information acceptance step of accepting knowledge graph information which is information included in the knowledge graph from a knowledge graph system that manages the knowledge graph;
a prompt construction step of constructing, on a basis of the document information and the knowledge graph information, a prompt for requesting presentation of information to be used for construction of an update query for updating the knowledge graph;
a prompt presentation step of presenting the prompt to a language model system that manages a language model;
a response information acceptance step of accepting response information representing a response from the language model system to the prompt;
an update query construction step of constructing the update query on a basis of the response information; and
an update query presentation step of presenting the update query to the knowledge graph system.

15. A program that causes a system to execute:
a document information acceptance step of accepting document information which is information included in a document that triggers updating of a knowledge graph;
a knowledge graph information acceptance step of accepting knowledge graph information which is information included in the knowledge graph from a knowledge graph system that manages the knowledge graph;
a prompt construction step of constructing, on a basis of the document information and the knowledge graph information, a prompt for requesting presentation of information to be used for construction of an update query for updating the knowledge graph;
a prompt presentation step of presenting the prompt to a language model system that manages a language model;
a response information acceptance step of accepting response information representing a response from the language model system to the prompt;
an update query construction step of constructing the update query on a basis of the response information; and
an update query presentation step of presenting the update query to the knowledge graph system.
